(19) United States
(12) Patent Application Publication
(10) Pub. No.: US 2026/0075129 A1
(43) Pub. Date: Mar. 12, 2026

(54) FOLDABLE ELECTRONIC DEVICE INCLUDING STRUCTURE FOR REDUCING DAMAGE OF HINGE

(71) Applicant: SAMSUNG ELECTRONICS CO., LTD., Suwon-si (KR)

(72) Inventors: Minsuk SONG, Suwon-si (KR); Jihoon Kim, Suwon-si (KR); Soli Jung, Suwon-si (KR); Junyoung Choi, Suwon-si (KR); Byounguk Yoon, Suwon-si (KR); Jaeyoung Jun, Suwon-si (KR); Jinug Choi, Suwon-si (KR); Jaeuk Ahn, Suwon-si (KR)

(73) Assignee: SAMSUNG ELECTRONICS CO., LTD., Suwon-si (KR)

(21) Appl. No.: 19/237,654

(22) Filed: Jun. 13, 2025

Related U.S. Application Data
(63) Continuation of application No. PCT/KR2025/007583, filed on Jun. 2, 2025.

(30) Foreign Application Priority Data
Sep. 6, 2024 (KR) 10-2024-0121939
Oct. 15, 2024 (KR) 10-2024-0140723

(51) Int. Cl. H04M 1/02

(52) U.S. Cl. CPC H04M 1/022; H04M 1/0268

(57) ABSTRACT

According to an embodiment, a multi-foldable electronic device may include a housing including a first housing part, a second housing part, and a third housing part. The multi-foldable electronic device may further include a first hinge assembly rotatably coupling the first housing part and the second housing part, and a second hinge assembly rotatably coupling the second housing part and the third housing part. The second housing part and the third housing part may be spaced apart from each other in an unfolded state of the multi-foldable electronic device. The multi-foldable electronic device may further include a stopper between the second housing part and the third housing part to support the second housing part and the third housing part in the unfolded state of the multi-foldable electronic device.

### CROSS-REFERENCE TO RELATED APPLICATIONS

This application is a continuation of International Application No. PCT/KR2025/007583 designating the United States, filed on Jun. 2, 2025, in the Korean Intellectual Property Receiving Office, which claims priority to Korean Patent Application Nos. 10-2024-0121939, filed on Sep. 6, 2024, and 10-2024-0140723, filed on Oct. 15, 2024, in the Korean Intellectual Property Office, the disclosures of each of which are incorporated by reference herein in their entireties.

### BACKGROUND

### 1. Field

Some embodiments of the present disclosure relate to a foldable electronic device including a structure for reducing damage to a hinge.

### 2. Description of Related Art

As a demand of a user is diversified, an electronic device may include a structure in which a display for displaying content is deformable. The electronic device may include a hinge structure for deforming the display. In the electronic device, a structure for reducing damage to the hinge structure may be required.

The above-described information may be provided for the purpose of helping understanding of the present disclosure. No determination is raised as to whether any of the above-described descriptions may be applied as a prior art related to the present disclosure.

### SUMMARY

According to some embodiments of the present disclosure, a multi-foldable electronic device may be provided and include: a housing comprising a first housing part, a second housing part, and a third housing part; a first hinge assembly rotatably coupling the first housing part and the second housing part; a second hinge assembly rotatably coupling the second housing part and the third housing part, the second hinge assembly comprising a sliding member comprising a first sink arm and a second sink arm, the sliding member configured to be slid in accordance with linkage between: spiral surfaces of the first sink arm and the second sink arm, and rotation of the third housing part and the second housing part with respect to each other; and a stopper coupled to the sliding member, the stopper configured move in accordance with the rotation of the third housing part with respect to the second housing part, wherein the stopper is configured to support the second housing part and the third housing part in an unfolded state of the multi-foldable electronic device by the stopper being between the second housing part and the third housing part.

According to some embodiments of the present disclosure, a foldable electronic device may be provided and include: a housing including a first housing part and a second housing part; a hinge assembly rotatably coupling the first housing part and the second housing part, wherein the first housing part and the second housing part are configured to be spaced apart from each other in an unfolded state of the foldable electronic device; a hinge cover covering a portion of the hinge assembly, the hinge cover including a through hole; and a stopper slidably coupled to the through hole, the stopper configured to protrude from an outer surface of the hinge cover through the through hole such as to support the first housing part and the second housing part in the unfolded state of the foldable electronic device.

### BRIEF DESCRIPTION OF DRAWINGS

FIG. 1 is a block diagram of an electronic device in a network environment according to various embodiments.

FIG. 2A illustrates an electronic device in a first state.

FIG. 2B illustrates an electronic device in a second state.

FIG. 3A is a top plan view of an electronic device in a first state from which a flexible display is removed.

FIG. 3B is a rear view of an electronic device in a first state from which a rear cover and a display are removed.

FIG. 4A illustrates an electronic device in a first state.

FIG. 4B illustrates an electronic device.

FIG. 5A illustrates a portion of an electronic device in a first state.

FIG. 5B illustrates a portion of an electronic device in a second state.

FIG. 5C illustrates a portion of a second hinge cover of an electronic device.

FIGS. 5D, 5E, 5F, and 5G illustrate a structure for movement of a stopper of an electronic device.

FIGS. 6A and 6B illustrate a second hinge assembly and a second hinge cover of an electronic device.

FIG. 6C illustrates a portion of an electronic device in a first state.

FIG. 6D illustrates a portion of an electronic device in a second state.

FIG. 6E illustrates a portion of an electronic device in a first state.

FIG. 6F illustrates a portion of an electronic device in a second state.

FIG. 7A illustrates a structure for movement of a stopper of an electronic device.

FIG. 7B illustrates a portion of an electronic device in a first state.

FIG. 7C illustrates a portion of an electronic device in a second state.

FIG. 7D illustrates a portion of an electronic device in a first state.

FIG. 7E illustrates a portion of an electronic device in a second state.

FIGS. 7F, 7G, and 7H illustrate a portion of an electronic device in an first state.

FIG. 8A illustrates a hinge bracket and a sliding member of an electronic device.

FIGS. 8B, 8C, and 8D are cross-sectional views of an hinge bracket and a sliding member cut along a line A-A′ of FIG. 8A.

FIG. 8E illustrates a hinge bracket and a sliding member of an electronic device.

FIG. 8F is a cross-sectional view of an hinge bracket and a sliding member cut along a line B-B′ of FIG. 8E.

FIGS. 8G and 8H illustrate a hinge bracket, a sliding member, and a fastening cover of an electronic device.

FIG. 8I is a cross-sectional view of an hinge bracket, a sliding member, and a fastening cover cut along a line C-C′ of FIG. 8H.

FIG. 9 illustrates a portion of an electronic device in a first state.

FIG. 10A illustrates a portion of an electronic device in a first state.

FIG. 10B illustrates a portion of an electronic device in a second state.

FIG. 10C illustrates a portion of an electronic device in a first state.

FIG. 10D illustrates a portion of an electronic device in a second state.

### DETAILED DESCRIPTION

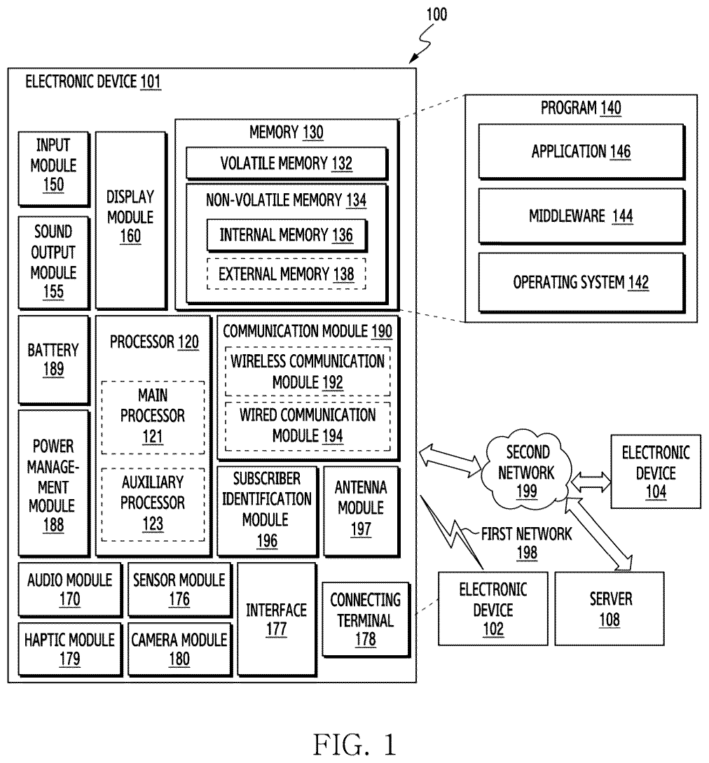

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one from among an electronic device 104 and a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, and/or an antenna module 197. In some embodiments, at least one of the components (e.g., the connecting terminal 178) may be omitted from the electronic device 101, and/or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, and/or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, for example, by the electronic device 101 where the artificial intelligence is performed or via a separate server (e.g., the server 108). Learning algorithms may include, but are not limited to, for example, supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 and/or the sensor module 176) of the electronic device 101. The various data may include, for example, software (e.g., the program 140) and input data or output data for a command related thereto. The memory 130 may include the volatile memory 132 and/or the non-volatile memory 134.

The program 140 may be stored in the memory 130 as software, and may include, for example, an operating system (OS) 142, middleware 144, and/or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), and/or a digital pen (e.g., a stylus pen).

The sound output module 155 may output sound signals to the outside of the electronic device 101. The sound output module 155 may include, for example, a speaker and/or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, and/or a projector and control circuitry to control a corresponding from among the display, hologram device, and projector. According to an embodiment, the display module 160 may include a touch sensor adapted to detect a touch, and/or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, and/or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, and/or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, and/or an electric stimulator.

The camera module 180 may capture a still image or moving images. According to an embodiment, the camera module 180 may include one or more lenses, image sensors, image signal processors, and/or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, and/or a fuel cell.

The communication module 190 may support establishing a direct (e.g., wired) communication channel or a wireless communication channel between the electronic device 101 and the external electronic device (e.g., the electronic device 102, the electronic device 104, and/or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, and/or a global navigation satellite system (GNSS) communication module) and/or a wired communication module 194 (e.g., a local area network (LAN) communication module and/or a power line communication (PLC) module). A corresponding one of these communication modules may communicate with the external electronic device via the first network 198 (e.g., a short-range communication network, such as Bluetooth™, wireless-fidelity (Wi-Fi) direct, and/or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, for example, new radio (NR) access technology. The NR access technology may support enhanced mobile broadband (eMBB), massive machine type communications (mMTC), and/or ultra-reliable and low-latency communications (URLLC). The wireless communication module 192 may support a high-frequency band (e.g., the mmWave band) to achieve, for example, a high data transmission rate. The wireless communication module 192 may support various technologies for securing performance on a high-frequency band, such as, for example, beamforming, massive multiple-input and multiple-output (massive MIMO), full dimensional MIMO (FD-MIMO), array antenna, analog beam-forming, and/or large scale antenna. The wireless communication module 192 may support various requirements specified in the electronic device 101, an external electronic device (e.g., the electronic device 104), and/or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, and/or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), and/or mobile industry processor interface (MIPI)).

According to an embodiment, commands or data may be transmitted or received between the electronic device 101 and the electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices (e.g., the electronic device 102, the electronic device 104, and/or the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, for example, distributed computing or mobile edge computing. In another embodiment, the electronic device 104 may include an internet-of-things (IoT) device. The server 108 may be an intelligent server using machine learning and/or a neural network. According to an embodiment, the electronic device 104 and/or the server 108 may be included in the second network 199. The electronic device 101 may be applied to intelligent services (e.g., smart home, smart city, smart car, or healthcare) based on 5G communication technology or IoT-related technology.

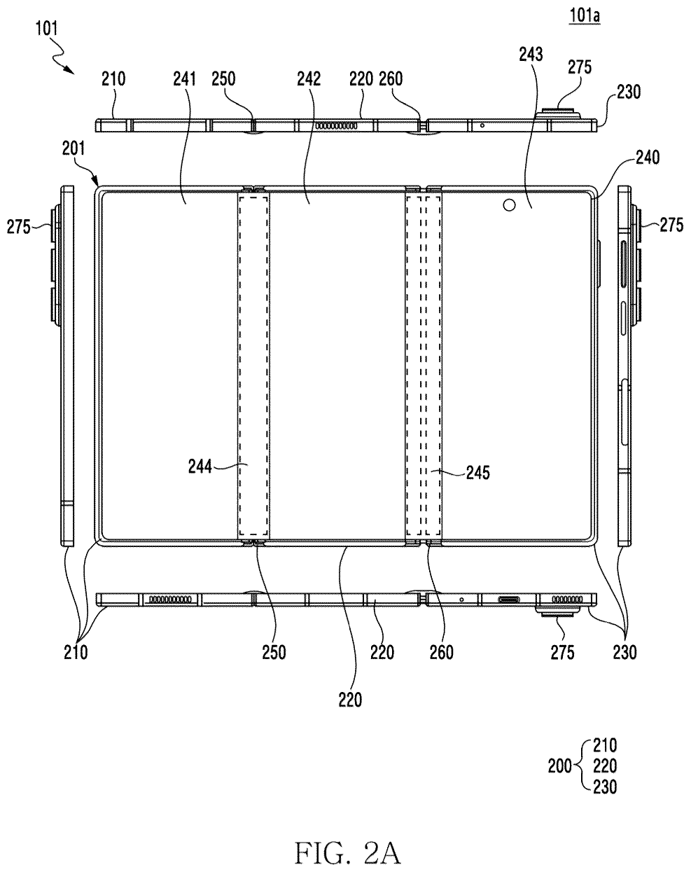

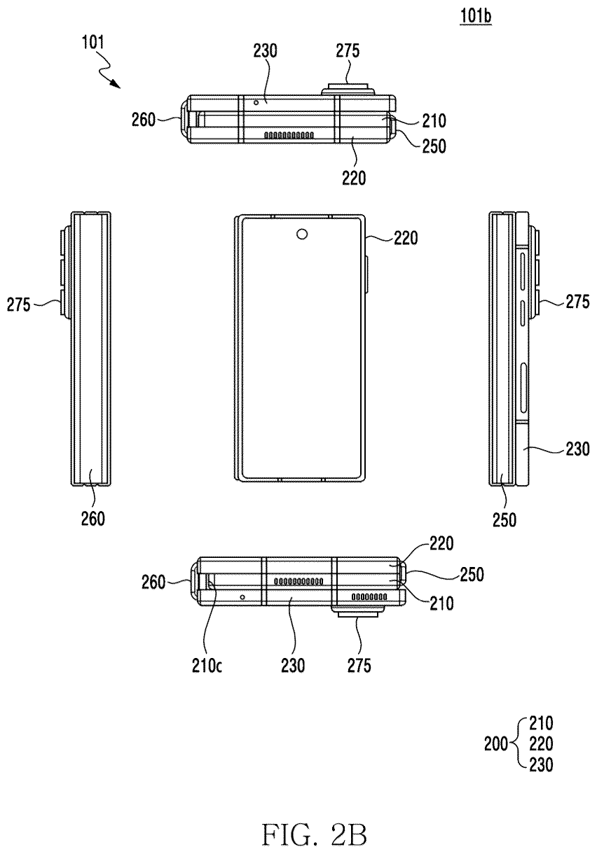

FIG. 2A illustrates an electronic device in a first state. FIG. 2B illustrates an electronic device in a second state. For example, FIG. 2A includes a front view, a first side view, a second side view, a bottom view, and a top view of the electronic device in the first state. For example, FIG. 2B includes a front view, a first side view, a second side view, a bottom view, and a top view of the electronic device in the second state.

Referring to FIGS. 2A and 2B, an electronic device 101 may include a housing 200, a flexible display 240, a first hinge assembly 250, and a second hinge assembly 260. The housing 200 may include a first housing part 210, a second housing part 220, and a third housing part 230. In view of the housing 200 including a plurality of housing parts (e.g., the first housing part 210, the second housing part 220, and the third housing part 230) and being foldable several times, the housing 200 may be referred to as a foldable housing. In view of the housing 200 being provided and/or the flexible display 240 being configured to be folded several times, the electronic device 101 may be referred to as a multi-foldable electronic device. However, embodiments of the present disclosure are not limited thereto.

The first housing part 210 may be rotatably coupled with the second housing part 220 by the first hinge assembly 250. The second housing part 220 and the first housing part 210 may be rotated with respect to the first hinge assembly 250. While the first housing part 210 is rotated with respect to the first hinge assembly 250, the second housing part 220 may be rotated with respect to the first hinge assembly 250. For example, when the second housing part 220 and the first housing part 210 are rotated with respect to the first hinge assembly 250, an angular displacement (or an angular change) of the second housing part 220 may be substantially the same as an angular displacement of the first housing part 210.

The third housing part 230 may be rotatably coupled with the second housing part 220 by the second hinge assembly 260. The second housing part 220 and the third housing part 230 may be rotated with respect to the second hinge assembly 260. While the second housing part 220 is rotated with respect to the second hinge assembly 260, the third housing part 230 may be rotated with respect to the second hinge assembly 260. For example, when the second housing part 220 and the third housing part 230 rotate with respect to the second hinge assembly 260, an angular displacement (or an angular change) of the second housing part 220 may be substantially the same as an angular displacement of the third housing part 230.

The first hinge assembly 250 and the second hinge assembly 260 may change a state of the electronic device. The first hinge assembly 250 and the second hinge assembly 260 may provide (or enable) a first state 101a of the electronic device 101 (or a first state 101a of the housing 200). The first state 101a of the electronic device 101 (or the first state 101a of the housing 200) may be described as an unfolded state of the electronic device 101 (or the housing 200). In the first state 101a, a front surface of the first housing part 210, a front surface of the second housing part 220, and a front surface of the third housing part 230 may define a front surface of the electronic device 101. In the first state 101a, the front surface of the first housing part 210, the front surface of the second housing part 220, and the front surface of the third housing part 230 may face the same direction as each other. In the first state 101a, the electronic device 101 may provide a large display region of the flexible display 240 to a user.

The first hinge assembly 250 and the second hinge assembly 260 may provide a second state 101b of the electronic device 101 (or a second state 101b of the housing 200). The second state 101b of the electronic device 101 (or the second state 101b of the housing 200) may be described as a multi-folded state of the electronic device 101 (or the housing 200). In the second state 101b, the front surface of the first housing part 210 and the front surface of the second housing part 220 may face opposite directions from each other, and the front surface of the second housing part 220 and the front surface of the third housing part 230 may face opposite directions from each other. In the second state 101b, the front surface of the first housing part 210 and the front surface of the third housing part 230 may face the same direction as each other. For example, in the second state 101b, the front surface of the second housing part 220 may face the front surface of the first housing part 210, and the front surface of the third housing part 230 may face a rear surface of the first housing part 210. In the second state 101b, the electronic device 101 may be folded to improve portability.

The first hinge assembly 250 and the second hinge assembly 260 may provide a third state of the electronic device 101. The third state of the electronic device 101 may be described as a state in which the electronic device 101 is partially folded and partially unfolded (or a single folded state or a half folded state). For example, in the third state, the front surface of the second housing part 220 and the front surface of the third housing part 230 may face the same direction as each other, and the front surface of the first housing part 210 and the front surface of the second housing part 220 may face opposite directions from each other. For example, in the third state, the first housing part 210 and the second housing part 220 may be folded, and the second housing part 220 and the third housing part 230 may be unfolded.

The flexible display 240 may at least partially define an exterior of the electronic device 101. The flexible display 240 may be partially disposed within the housing 200. The flexible display 240 may define the front surface of the electronic device 101. The flexible display 240 may include a first display portion 241, a second display portion 242, a third display portion 243, a fourth display portion 244, and a fifth display portion 245. The first display portion 241 of the flexible display 240 may be disposed on the front surface of the first housing part 210. The second display portion 242 of the flexible display 240 may be disposed on the front surface of the second housing part 220. The third display portion 243 of the flexible display 240 may be disposed on the front surface of the third housing part 230. The fourth display portion 244 of the flexible display 240 may be disposed between the first display portion 241 and the second display portion 242 of the flexible display 240. For example, the fourth display portion 244 of the flexible display 240 may be disposed on the first hinge assembly 250 connecting the first housing part 210 and the second housing part 220. The fifth display portion 245 of the flexible display 240 may be disposed between the second display portion 242 and the third display portion 243 of the flexible display 240. For example, the fifth display portion 245 of the flexible display 240 may be disposed on the second hinge assembly 260 connecting the second housing part 220 and the third housing part 230.

In the first state 101a, an entire display region of the flexible display 240 may be viewed from a front surface of the housing 200. For example, the first display portion 241, the second display portion 242, the third display portion 243, the fourth display portion 244, and the fifth display portion 245 of the flexible display 240 may be visually exposed. The electronic device 101 may provide a large display region including the first display portion 241, the second display portion 242, the third display portion 243, the fourth display portion 244, and the fifth display portion 245 to the user. In the second state 101b, the display region of the flexible display 240 may not be visible. For example, the first display portion 241, the second display portion 242, the third display portion 243, the fourth display portion 244, and the fifth display portion 245 of the flexible display 240 may not be visually exposed. In the third state, the display region of the flexible display 240 may be partially visible from the front surface of the third housing part 230. For example, the third display portion 243 may be visually exposed, and the first display portion 241 and the second display portion 242 may not be visually exposed.

As a non-limiting example, when the flexible display 240 is used to display a screen in the first state 101a of the electronic device 101, all portions (e.g., the first display portion 241, the second display portion 242, the third display portion 243, the fourth display portion 244, and the fifth display portion 245) of the flexible display 240 may be activated. As a non-limiting example, in the second state 101b, all portions (e.g., the first display portion 241, the second display portion 242, the third display portion 243, the fourth display portion 244, and the fifth display portion 245) of the flexible display 240 may be deactivated. As a non-limiting example, in the third state of the electronic device 101, when the flexible display 240 is used to display a screen, the third display portion 243 may be activated, and other portions (e.g., the first display portion 241, the second display portion 242, the fourth display portion 244, and the fifth display portion 245) of the flexible display 240 may be deactivated.

The first hinge assembly 250 and the second hinge assembly 260 may face substantially the same direction as a facing direction of the first display portion 241 of the flexible display 240, the second display portion 242 of the flexible display 240, and the third display portion 243 of the flexible display 240. In the first state 101a, the fourth display portion 244 and the fifth display portion 245 may be disposed on substantially the same horizontal plane as the first display portion 241, the second display portion 242, and the third display portion 243.

The first hinge assembly 250 and the second hinge assembly 260 may provide the second state 101b of the electronic device 101. In the second state 101b, the second display portion 242 of the flexible display 240 may face the first display portion 241 of the flexible display 240, and the third display portion 243 of the flexible display 240 may face the rear surface of the first housing part 210. In the second state 101b, the fourth display portion 244 of the flexible display 240 may be folded such that the first display portion 241 of the flexible display 240 and the second display portion 242 of the flexible display 240 face different directions from each other. In the second state 101b, the fifth display portion 245 of the flexible display 240 may be folded such that the second display portion 242 of the flexible display 240 and the third display portion 243 of the flexible display 240 face different directions from each other.

In the second state 101b, the first housing part 210 may be disposed between the second housing part 220 and the third housing part 230. In the second state 101b, the fifth display portion 245 of the flexible display 240 disposed on the second hinge assembly 260 may partially face a lateral surface of the first housing part 210. For example, in the second state 101b, in order to provide visual information to the user, a sub-display may be additionally disposed on a rear surface of the second housing part 220. However, embodiments of the present disclosure are not limited thereto.

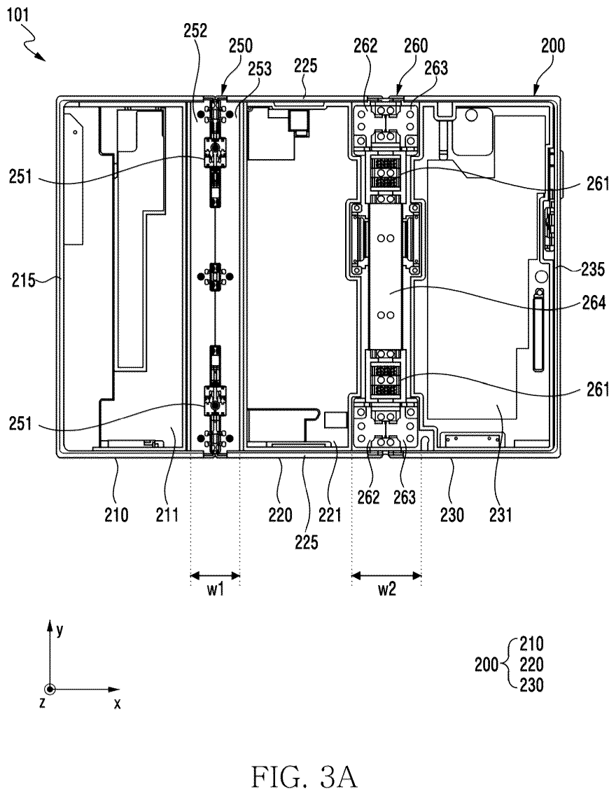

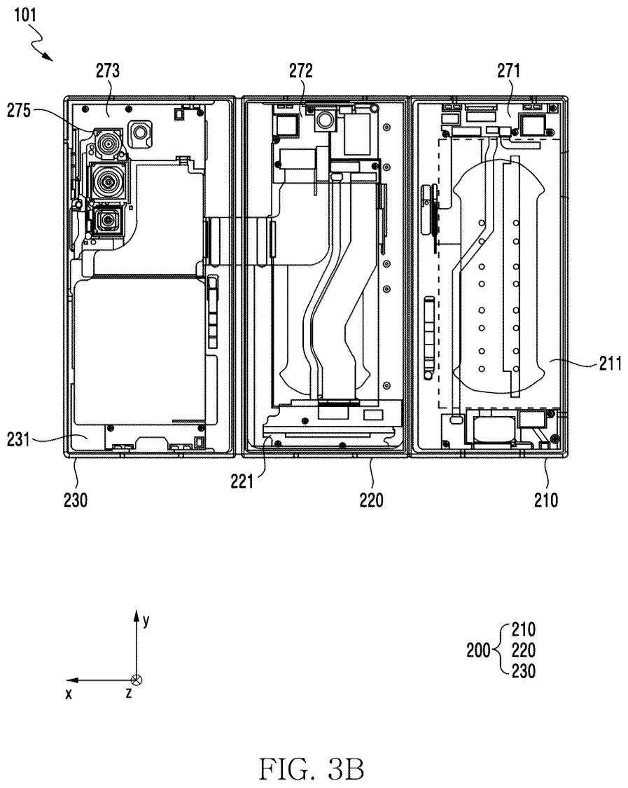

FIG. 3A is a top plan view of an electronic device in a first state from which a flexible display is removed. FIG. 3B is a rear view of an electronic device in a first state from which a rear cover and a display are removed.

Referring to FIGS. 3A and 3B, an electronic device 101 may include a first hinge assembly 250 and a second hinge assembly 260. A first width w1 of the first hinge assembly 250 may be narrower than a second width w2 of the second hinge assembly 260. A difference between the first width w1 of the first hinge assembly 250 and the second width w2 of the second hinge assembly 260 may be equal to or greater than a thickness of a first housing part 210. For example, the second hinge assembly 260 may have the second width w2 wider than the first width w1 such that the first housing part 210 is disposed between a second housing part 220 and a third housing part 230 in a second state 101b. The first hinge assembly 250 may be referred to as a narrow hinge structure in terms of having a narrower width than the second hinge assembly 260. The second hinge assembly 260 may be referred to as a wide hinge structure in terms of having a wider width than the first hinge assembly 250.

The first hinge assembly 250 may include a first set 251 of gears, a first hinge plate 252, and a second hinge plate 253. The first hinge plate 252 may be coupled to a first supporting portion 211 of the first housing part 210. The second hinge plate 253 may be coupled to a second supporting portion 221 of the second housing part 220. Gears included in the first set 251 of the gears may be configured to rotate the first hinge plate 252 and the second hinge plate 253. For example, the gears included in the first set 251 of the gears may rotate the second hinge plate 253 (or the second housing part 220) in linkage with rotation of the first hinge plate 252 (or the first housing part 210). After the first hinge plate 252 (or the first housing part 210) is rotated, the gears included in the first set 251 of the gears may be rotated according to the rotation of the first hinge plate 252 (or the first housing part 210). The second hinge plate 253 (or the second housing part 220) may be rotated in linkage with the rotation of the first hinge plate 252 according to the rotation of the gears included in the first set 251 the of gears.

The second hinge assembly 260 may include a second set 261 of gears, a third hinge plate 262, a fourth hinge plate 263, and a supporting plate 264. The third hinge plate 262 may be coupled to the second supporting portion 221 of the second housing part 220. The fourth hinge plate 263 may be coupled to a third supporting portion 231 of the third housing part 230. Gears included in the second set 261 of the gears may be configured to rotate the third hinge plate 262 and the fourth hinge plate 263. For example, the gears included in the second set 261 of the gears may rotate the fourth hinge plate (263 (or the third housing part 230) in linkage with rotation of the third hinge plate 262 (or the second housing part 220). After the third hinge plate 262 (or the second housing part 220) is rotated, the gears included in the second set 261 of the gears may be rotated according to the rotation of the third hinge plate 262 (or the second housing part 220). The fourth hinge plate 263 (or the third housing part 230) may be rotated in linkage with the rotation of the third hinge plate 262 according to the rotation of the gears included in the second set 261 of the gears.

The electronic device 101 may include a first printed circuit board 271, a second printed circuit board 272, and a third printed circuit board 273. Various hardware components may be mounted on each of the printed circuit boards (e.g., the first printed circuit board 271, the second printed circuit board 272, and the third printed circuit board 273).

The first printed circuit board 271 may be disposed in the first supporting portion 211 of the first housing part 210. A hardware component in the first housing part 210 may be disposed on the first printed circuit board 271. The second printed circuit board 272 may be disposed in the second supporting portion 221 of the second housing part 220. A hardware component in the second housing part 220 may be disposed on the second printed circuit board 272. The third printed circuit board 273 may be disposed in the third supporting portion 231 of the third housing part 230. A hardware component (e.g., a rear camera 275) in the third housing part 230 may be disposed on the third printed circuit board 273.

The hardware component disposed on the first printed circuit board 271 may support the hardware component disposed on the second printed circuit board 272 and/or the hardware component disposed on the third printed circuit board 273, or may independently operate.

The hardware component disposed on the second printed circuit board 272 may support the hardware component disposed on the first printed circuit board 271 or the third printed circuit board 273, or may independently operate. The hardware components disposed on the second printed circuit board 272 may include a speaker, a front camera, and/or display driving circuitry.

The hardware component disposed on the third printed circuit board 273 may include at least one processor including processing circuitry, memory including one or more storage media, communication circuitry, and the rear camera 275. The rear camera 275 may be exposed through a structure (e.g., an opening) of a rear surface of the third housing part 230.

The electronic device 101 may further include batteries. Each of the batteries may be attached to the supporting portions (e.g., the first supporting portion 211, the second supporting portion 221, and the third supporting portion 231) included in the housing parts (e.g., the first housing part 210, the second housing part 220, and the third housing part 230). The supporting portions (e.g., the first supporting portion 211, the second supporting portion 221, and the third supporting portion 231) may support rechargeable batteries.

A housing 200 may include protective covers (e.g., a first protective cover 215, a second protective cover 225, and a third protective cover 235). For example, the protective covers (e.g., the first protective cover 215, the second protective cover 225, and the third protective cover 235) may form a periphery of the electronic device 101 in a first state 101a. For example, the first housing part 210 may include the first protective cover 215 at least partially surrounding the first supporting portion 211. The second housing part 220 may include the second protective cover 225 at least partially surrounding the second supporting portion 221. The third housing part 230 may include the third protective cover 235 at least partially surrounding the third supporting portion 231. The second protective cover 225 may be positioned between the first protective cover 215 and the third protective cover 235 in the first state 101a of the electronic device 101. The protective covers (e.g., the first protective cover 215, the second protective cover 225, and the third protective cover 235) may be referred to as peripheral portion and/or a deco of the housing 200 in terms of being disposed along the periphery of the electronic device 101 to protect a periphery of a flexible display 240, but embodiments of the present disclosure are not limited thereto.

The first housing part 210 and the third housing part 230 are described to rotate in an opposite direction with respect to the second housing part 220, but are not limited thereto. For example, while changing from the first state 101a to the second state 101b, the first housing part 210 may rotate counterclockwise with respect to the second housing part 220, and the third housing part 230 may rotate counterclockwise with respect to the second housing part 220. As the first housing part 210 and the third housing part 230 rotate in the same direction, a portion of a display region of the flexible display 240 may be visually exposed in the second state. However, embodiments of the present disclosure are not limited thereto, and for example, while changing from the first state 101a to the second state 101b, the first housing part 210 may rotate clockwise with respect to the second housing part 220, and the third housing part 230 may rotate counterclockwise with respect to the second housing part 220.

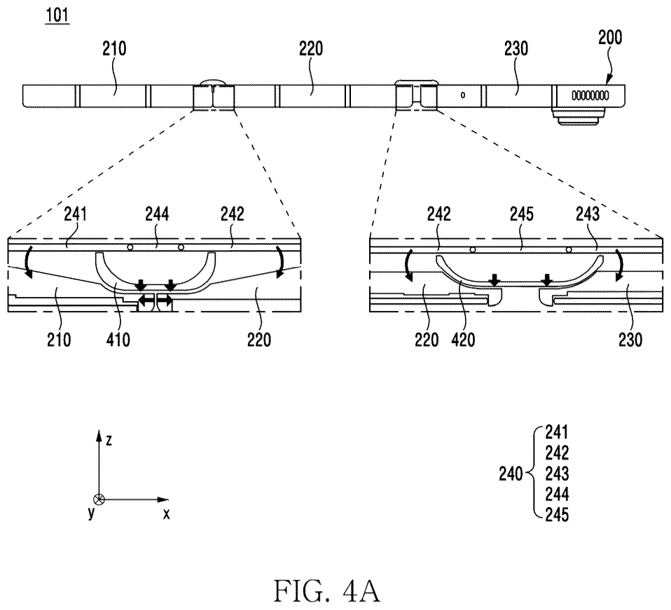

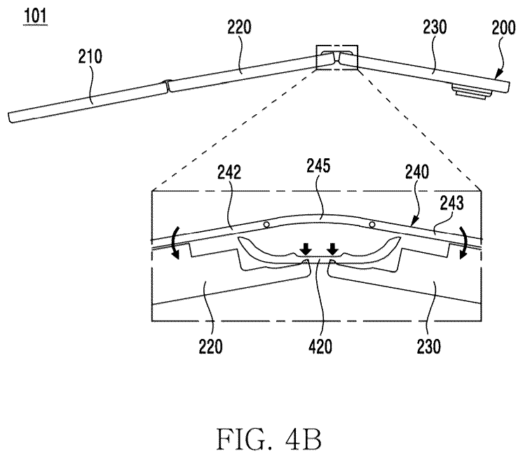

FIG. 4A illustrates an electronic device in a first state. FIG. 4B illustrates an electronic device.

Referring to FIGS. 4A and 4B, an electronic device 101 may include a housing 200 including a first housing part 210, a second housing part 220, and a third housing part 230. The electronic device 101 may include a first hinge assembly (e.g., the first hinge assembly 250 of FIG. 3A) rotatably coupling the first housing part 210 and the second housing part 220, and a second hinge assembly (e.g., the second hinge assembly 260 of FIG. 3A) rotatably coupling the second housing part 220 and the third housing part 230. The electronic device 101 may include a flexible display 240 including display portions (e.g., the first display portion 241, the second display portion 242, the third display portion 243, the fourth display portion 244, and the fifth display portion 245).

The flexible display 240 may be coupled to the housing 200. The flexible display 240 may be partially bent by the first hinge assembly 250 and the second hinge assembly 260. For example, the flexible display 240 may be accommodated in the first housing part 210, the second housing part 220, and the third housing part 230. For example, the first display portion 241 may be coupled to the first housing part 210. The second display portion 242 may be coupled to the second housing part 220. The third display portion 243 may be coupled to the third housing part 230. For example, the fourth display portion 244 may be configured to be deformed by the first hinge assembly 250. For example, the fifth display portion 245 may be configured to be deformed by the second hinge assembly 260. For example, with reference to FIG. 3A and FIG. 3B together, a width (or an area) of the fifth display portion 245 may be greater than a width (or an area) of the fourth display portion 244 to provide a second state 101b (or a multi-folded state) of the electronic device 101. However, embodiments of the present disclosure are not limited thereto.

The electronic device 101 may include a first hinge cover 410 surrounding a portion of the first hinge assembly 250, and a second hinge cover 420 surrounding a portion of the second hinge assembly 260. For example, the first hinge cover 410 may be positioned under the fourth display portion 244. The first hinge assembly 250 may be at least partially disposed between the first hinge cover 410 and the fourth display portion 244. For example, the second hinge cover 420 may be positioned under the fifth display portion 245. The second hinge assembly 260 may be at least partially disposed between the second hinge cover 420 and the fifth display portion 245. For example, with reference to FIGS. 3A and 3B together, the first hinge cover 410 and the second hinge cover 420 may be more exposed to the outside of the electronic device 101 in the second state 101b of the electronic device 101 than in the first state 101a, respectively. For example, while the electronic device 101 changes from the first state 101a to the second state 101b, an outer surface of the first hinge cover 410 may be at least partially covered by the first housing part 210 and the second housing part 220. For example, while the electronic device 101 changes from the first state 101a to the second state 101b, an outer surface of the second hinge cover 420 may be at least partially covered by the second housing part 220 and the third housing part 230. However, embodiments of the present disclosure are not limited thereto. By including the first hinge cover 410 and the second hinge cover 420, the electronic device 101 may reduce damage to the first hinge assembly 250 and the second hinge assembly 260 by external impact in a plurality of states of the electronic device 101.

Referring to FIGS. 2A to 3B together, the first housing part 210 and the second housing part 220 may be in contact with each other in the first state 101a of the electronic device 101. The second housing part 220 and the third housing part 230 may be spaced apart from each other in the first state 101a to accommodate the first housing part 210 between the second housing part 220 and the third housing part 230 in the second state 101b of the electronic device 101. For example, a width of the first hinge cover 410 surrounding the first hinge assembly 250, referred to as a narrow hinge, may be smaller than a width of the second hinge cover 420 surrounding the second hinge assembly 260, referred to as a wide hinge. Since the width of the second hinge cover 420 may be relatively larger than the width of the first hinge cover 410, the second housing part 220 and the third housing part 230 partially surrounding the second hinge cover 420 in the first state 101a of the electronic device 101 may be spaced apart from each other.

For example, as illustrated in FIGS. 4A and 4B, the first housing part 210 and the second housing part 220 may be in contact with each other in the first state 101a of the electronic device 101. For example, the first housing part 210 and the second housing part 220 may be configured to be in contact with each other before the first hinge cover 410 contacts the first housing part 210 and the second housing part 220. The first housing part 210 and the second housing part 220 may respectively support each other before contacting the first hinge cover 410, thereby protecting the first hinge cover 410 (or the first hinge assembly 250) that is at least partially surrounded by the first housing part 210 and the second housing part 220.

For example, in the first state 101a of the electronic device 101, the second housing part 220 and the third housing part 230 may be spaced apart from each other. Since the second housing part 220 and the third housing part 230 are spaced apart from each other, as illustrated in FIG. 4B, the second hinge cover 420 (or the second hinge assembly 260) may be damaged by the housing parts (e.g., the second housing part 220 and the third housing part 230) when the electronic device 101, in a comparative embodiment, performs a folding operation or external impact is applied. For example, as illustrated in FIG. 4B, while the electronic device 101, in the comparative embodiment, performs the folding operation, the fifth display portion 245 may be damaged by over rotation of the third housing part 230 with respect to the second housing part 220, or the second hinge cover 420 and/or the second hinge assembly 260 may be damaged by contacting the second housing part 220, the third housing part 230, and the second hinge cover 420. In the electronic device 101, a structure for supporting the second housing part 220 and the third housing part 230 spaced apart from each other to protect the second hinge cover 420 having a relatively wide width and/or the second hinge assembly 260 surrounded by the second hinge cover 420 may be provided to avoid the problem of the comparative embodiment. The structure is described below.

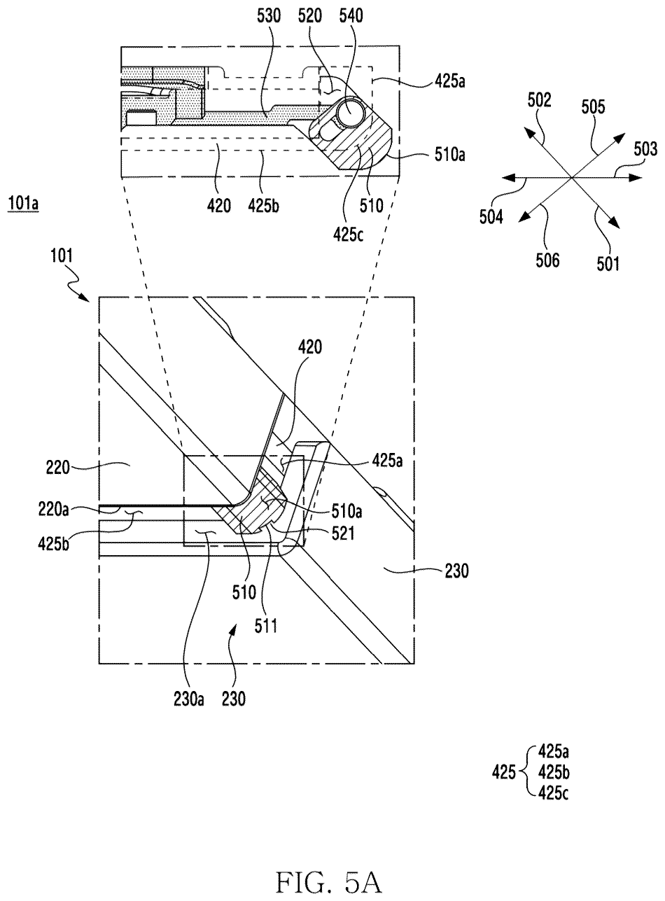

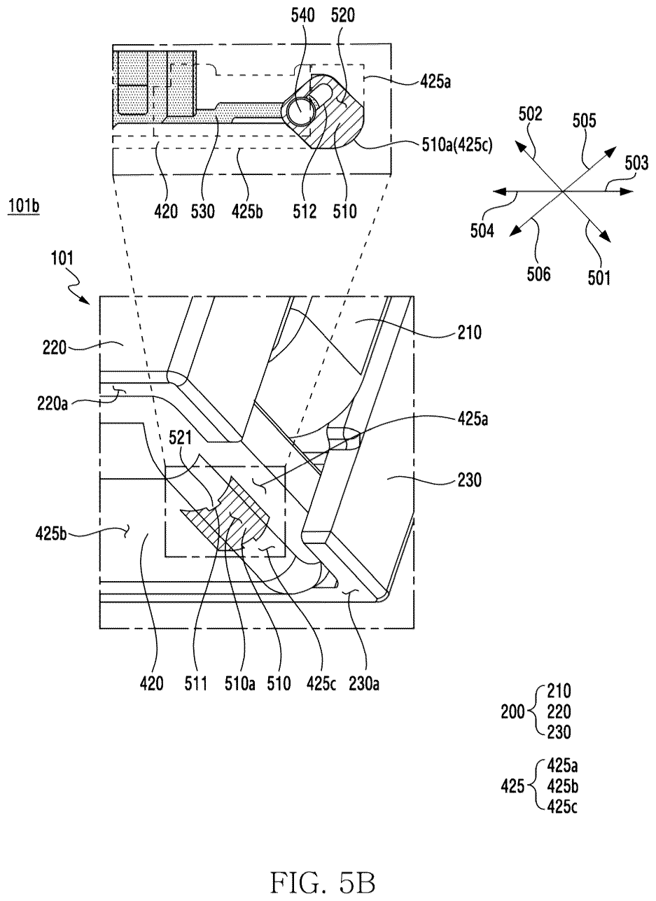

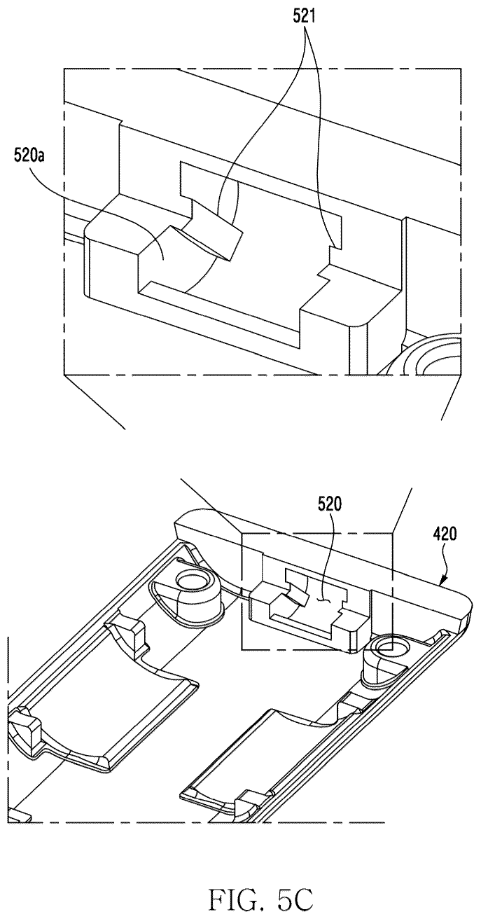

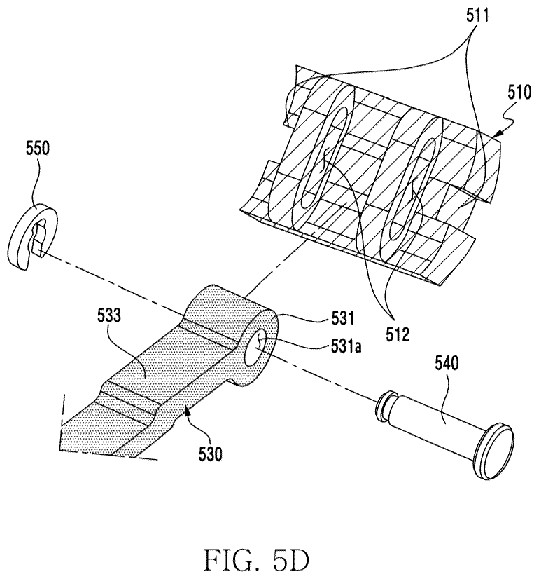

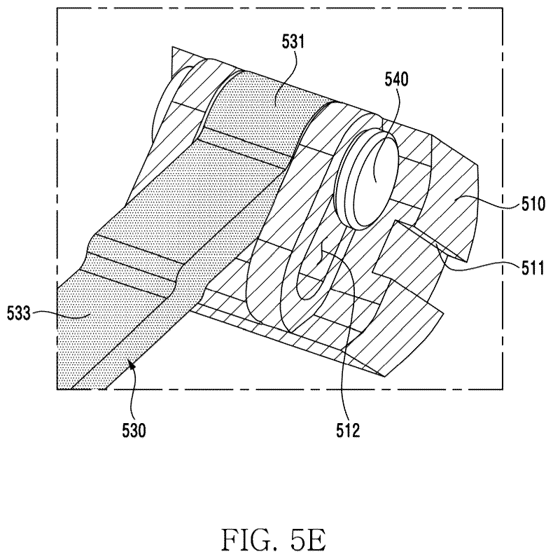

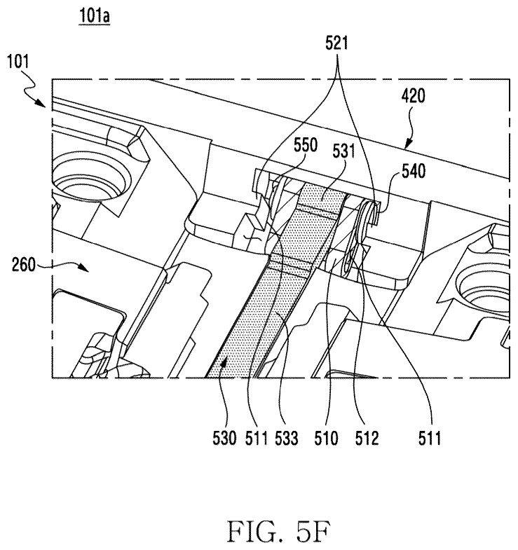

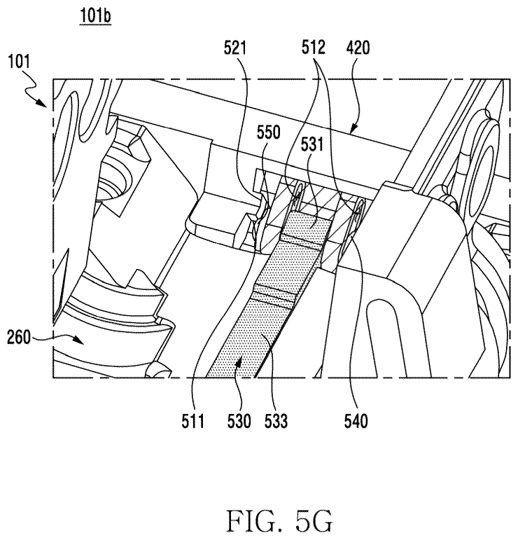

FIG. 5A illustrates a portion of an electronic device in a first state. FIG. 5B illustrates a portion of an electronic device in a second state. FIG. 5C illustrates a portion of a second hinge cover of an electronic device. FIGS. 5D, 5E, 5F, and 5G illustrate a structure for movement of a stopper of an electronic device.

Referring to FIGS. 5A, 5B, 5C, 5D, 5E, 5F, and 5G, an electronic device 101 may include a housing 200 including a first housing part 210, a second housing part 220, and a third housing part 230. The electronic device 101 may include a first hinge assembly (e.g., the first hinge assembly 250 of FIG. 3A) rotatably coupling the first housing part 210 and the second housing part 220. The electronic device 101 may include a second hinge assembly 260 rotatably coupling the second housing part 220 and the third housing part 230. The second housing part 220 and the third housing part 230 may be spaced apart from each other in a first state 101a of the electronic device 101. However, embodiments of the present disclosure are not limited thereto, and for example, the electronic device 101 illustrated in and described with reference to FIGS. 5A to 5G may include structures and/or configurations illustrated in and described with reference to FIGS. 2A to 4B. Additionally, hereinafter, an overlapping description of structures and/or configurations that have the same reference numerals as the structures and/or the configurations illustrated in and described with reference to FIGS. 2A to 4B may be omitted.

The electronic device 101 may include a stopper 510 positioned between the second housing part 220 and the third housing part 230 to support the second housing part 220 and the third housing part 230 in the first state 101a of the electronic device 101. For example, the stopper 510 may be disposed between a lateral surface 220a of the second housing part 220 and a lateral surface 230a of the third housing part 230 in the first state 101a of the electronic device 101. For example, the stopper 510 may be in contact with the second housing part 220 and the third housing part 230 in the first state 101a of the electronic device 101. The stopper 510 may be pressed by the second housing part 220 and the third housing part 230 in the first state 101a. The stopper 510 may support the second housing part 220 through a repulsive force caused by pressure from the second housing part 220. The stopper 510 may support the third housing part 230 through a repulsive force by pressure from the third housing part 230. For example, the stopper 510 may be at least partially exposed to the outside of the electronic device 101 in the first state 101a of the electronic device 101. The stopper 510 may be disposed between a gap between the second housing part 220 and the third housing part 230, or may be exposed to the outside through the gap. For example, the stopper 510 may be interposed between the second housing part 220 and the third housing part 230 in the first state 101a of the electronic device 101, thereby preventing the third housing part 230 from being over rotated with respect to the second housing part 220 in the first state 101a. The stopper 510 may reduce damage to a second hinge cover 420 (or the second hinge assembly 260) due to the over rotation by preventing the over rotation of the third housing part 230 with respect to the second housing part 220.

The second housing part 220 and the third housing part 230 may be configured to be in contact with the stopper 510 before the second hinge cover 420 contacts the second housing part 220 and the third housing part 230. For example, with reference to FIG. 4A together, the first housing part 210 and the second housing part 220 in the first state 101a of the electronic device 101 may protect a first hinge cover 410 (or the first hinge assembly 250) by contacting each other before the first hinge cover 410 contacts the first housing part 210 and the second housing part 220. For example, unlike FIG. 4A and FIG. 4B, the second housing part 220 and the third housing part 230 in the first state 101a of the electronic device 101 may be in contact with the stopper 510 before the second hinge cover 420 contacts the second housing part 220 and the third housing part 230, thereby reducing damage to the second hinge cover 420 (or the second hinge assembly 260) due to the contact between the housing parts (e.g., the second housing part 220 and the third housing part 230) and the second hinge cover 420.

The second hinge cover 420 may include a through hole 520 accommodating the stopper 510. The stopper 510 may be configured to protrude through the through hole 520 from an outer surface 425 of the second hinge cover 420 to be in contact with the second housing part 220 and the third housing part 230 in the first state 101a of the electronic device 101. The stopper 510 may be configured to be disposed in the through hole 520 to form a continuous surface together with the outer surface 425 of the second hinge cover 420 in a second state 101b of the electronic device 101.

For example, the stopper 510 may be movable with respect to the second hinge cover 420. For example, the stopper 510 may be in linkage with the second hinge assembly 260 to be slidable with respect to the second hinge cover 420 while a state of the electronic device 101 changes. For example, as illustrated, the stopper 510 may move in a direction 501 and a direction 502 opposite to the direction 501 with respect to the second hinge cover 420 (or the through hole 520) according to rotation of the third housing part 230 with respect to the second housing part 220.

For example, the through hole 520 of the second hinge cover 420 may partially expose the stopper 510 to the outside of the electronic device 101. For example, the through hole 520 may be formed in a portion of the second hinge cover 420 exposed to the outside of the electronic device 101 in the first state 101a of the electronic device 101. For example, the stopper 510 may be coupled to the through hole 520 to be slidable inside the through hole 520. For example, the through hole 520 may have a length in a direction corresponding to the directions 501 and 502 in which the stopper 510 moves to guide a moving direction of the stopper 510.

For example, in the first state 101a of the electronic device 101, the stopper 510 may protrude from the outer surface 425 of the second hinge cover 420 through the through hole 520. For example, while the electronic device 101 changes from the second state 101b to the first state 101a, the stopper 510 may be protruded from the outer surface 425 of the second hinge cover 420 by moving in the direction 501. The stopper 510 may at least partially face the second housing part 220 (or the lateral surface 220a) and the third housing part 230 (or the lateral surface 230a) by protruding from the outer surface 425 in the first state 101a. The stopper 510 may be configured to support the second housing part 220 and the third housing part 230 by at least partially protruding from the outer surface 425 of the second hinge cover 420 through the through hole 520 in the first state 101a. However, embodiments of the present disclosure are not limited thereto.

For example, the stopper 510 may form a continuous surface with the outer surface 425 of the second hinge cover 420 by being positioned inside the through hole 520 in the second state 101b of the electronic device 101. For example, an outer surface 510a of the stopper 510 may cover an inlet of the through hole 520 in the second state 101b of the electronic device 101. The outer surface 510a of the stopper 510 may have a shape corresponding to the inlet of the through hole 520 to form the continuous surface with the outer surface 425 of the second hinge cover 420. For example, while the electronic device 101 changes from the first state 101a to the second state 101b, the stopper 510 may form the continuous surface with the outer surface 425 of the second hinge cover 420 by moving in the direction 502. The stopper 510 may provide a user of the electronic device 101 with an aesthetic sense of the electronic device 101 in the second state 101b by forming the continuous surface with the second hinge cover 420 in the second state 101b. However, embodiments of the present disclosure are not limited thereto.

The outer surface 425 of the second hinge cover 420 may include a vertical surface 425a, a horizontal surface 425b perpendicular to the vertical surface 425a, and a curved surface 425c extending from the vertical surface 425a to the horizontal surface 425b. The through hole 520 may expose the stopper 510 to the outside of the electronic device 101 by being formed in a portion of the vertical surface 425a, a portion of the horizontal surface 425b, and a portion of the curved surface 425c.

For example, the vertical surface 425a and the horizontal surface 425b may be formed to be perpendicular to each other. The curved surface 425c may connect the vertical surface 425a and the horizontal surface 425b by at least partially being bent. For example, the portion of the vertical surface 425a, the portion of the horizontal surface 425b, and the portion of the curved surface 425c may be exposed to the outside of the electronic device 101 by the second housing part 220 and the third housing part 230 spaced apart from each other in the first state 101a of the electronic device 101. The through hole 520 of the second hinge cover 420 may protrude the stopper 510 to the outside in the first state 101a by being formed in the portion of the vertical surface 425a, the portion of the horizontal surface 425b, and the portion of the curved surface 425c. For example, the outer surface 510a of the stopper 510 may have a shape that is at least partially curved to form the continuous surface with the curved surface 425c in the second state 101b of the electronic device 101, but embodiments of the present disclosure are not limited thereto.

For example, the stopper 510 may be in contact with the lateral surface 220a of the second housing part 220 and the lateral surface 230a of the third housing part 230 facing the lateral surface 220a of the second housing part 220 in the first state 101a of the electronic device 101. For example, as the directions 501 and 502 (moving directions) in which the stopper 510 moves may be inclined with respect to directions 503 and 504 parallel to a direction in which the vertical surface 425a of the second hinge cover 420 faces, the stopper 510 may be in contact with corner regions among the lateral surface 220a of the second housing part 220 and the lateral surface 230a of the third housing part 230. By contacting the corner regions, the stopper 510 may improve support to the second housing part 220 and the third housing part 230 in the first state 101a of the electronic device 101.

The second hinge cover 420 may guide a position of the stopper 510 and may include a guide rail 521 protruding from an inner surface 520a of the through hole 520. The stopper 510 may include a guide groove 511 slidably coupled to the guide rail 521 such that the stopper 510 moves in the direction 501 and the direction 502 opposite to the direction 501 with respect to the second hinge cover 420. For example, as illustrated in FIG. 5C, a pair of the guide rails 521 may face each other by protruding from the inner surface 520a of the through hole 520 of the second hinge cover 420. For example, the guide rail 521 may have a length in the directions 501 and 502 to guide movement of the stopper 510 in the directions 501 and 502. For example, the guide groove 511 may have a shape corresponding to the guide rail 521 of the second hinge cover 420. For example, the guide grooves 511 may be formed on lateral surfaces of the stoppers 510 in order to form a pair with the guide rail 521. For example, the guide groove 511 may have a length in the directions 501 and 502 along which the stopper 510 moves. For example, the guide groove 511 may movably couple the stopper 510 to the second hinge cover 420 (or the through hole 520) by being slidably coupled to the guide rail 521. However, embodiments of the present disclosure are not limited thereto.

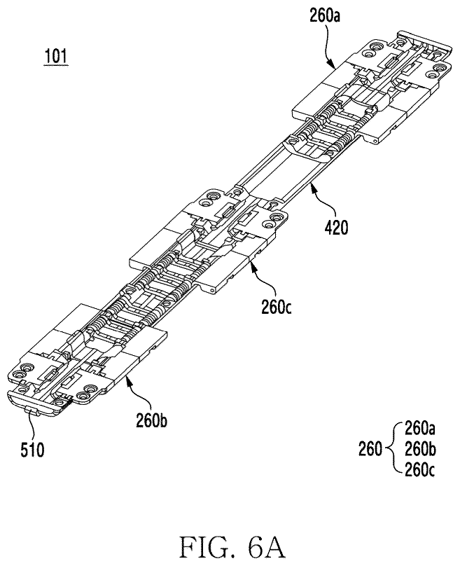

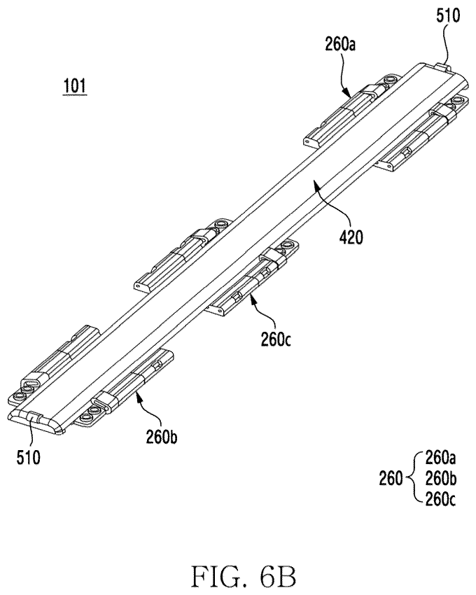

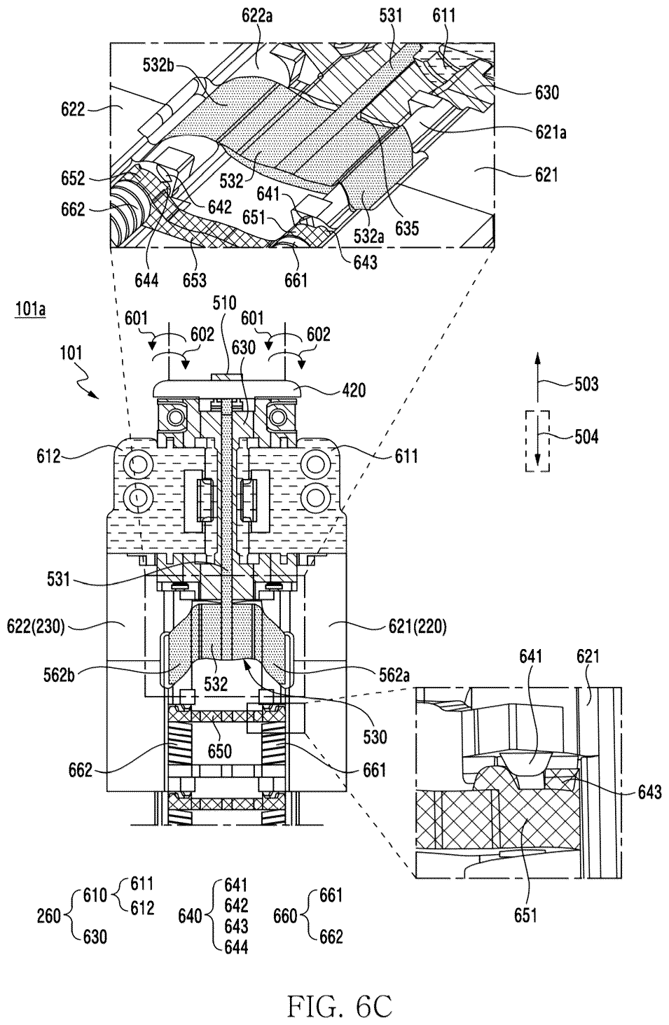

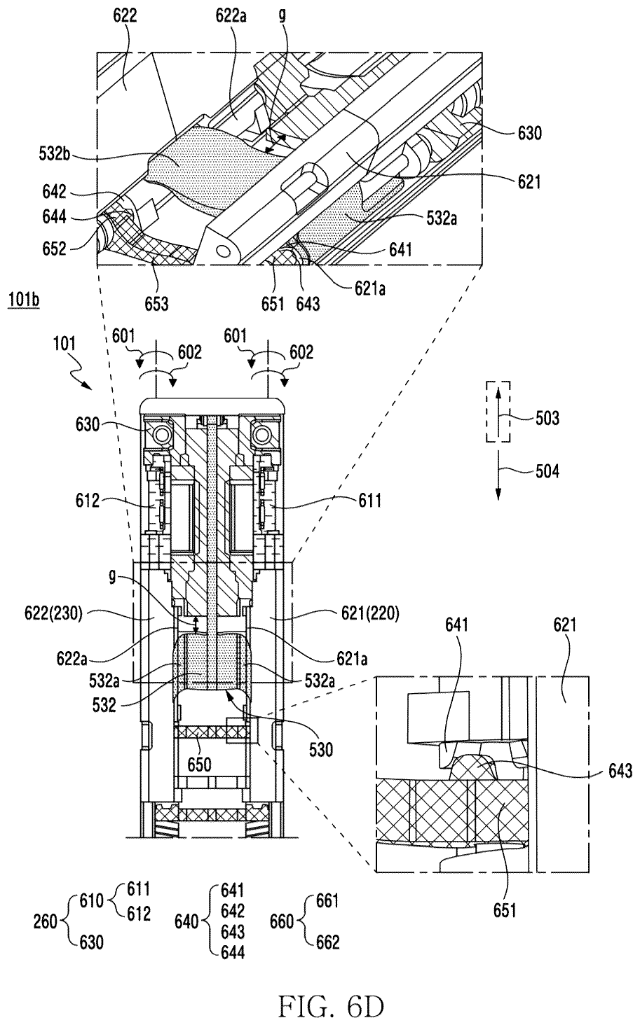

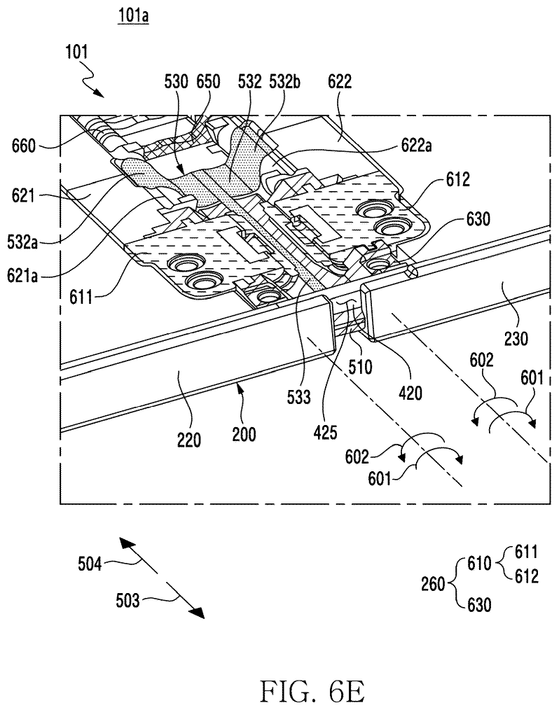

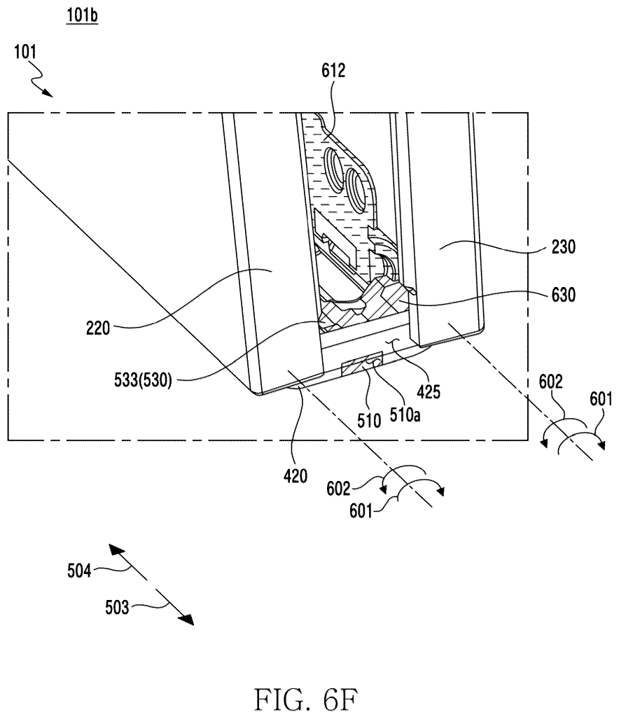

The electronic device 101 may include a sliding member 530 for moving the stopper 510. The sliding member 530 may include a first portion 531 coupled to the stopper 510, a second portion (e.g., a second portion 532 of FIG. 6C) configured to slide by the rotation of the third housing part 230 with respect to the second housing part 220, and a third portion 533 extending from the first portion 531 to the second portion 532 and providing a driving force to move the stopper 510 through the second portion 532.

For example, the sliding member 530 may be provided as a portion of the second hinge assembly 260 or may be movably coupled with respect to the second hinge assembly 260. For example, the sliding member 530 may be at least partially positioned between the second housing part 220 and the third housing part 230 in the housing 200. For example, the sliding member 530 may move the stopper 510 in the directions 501 and 502 by axial moving in directions 503 and 504 through the rotation of the third housing part 230 with respect to the second housing part 220. For example, the first portion 531 of the sliding member 530 may be disposed in the through hole 520 together with the stopper 510 by being coupled with the stopper 510. For example, the third portion 533 of the sliding member 530 may move the first portion 531 by extending from the first portion 531 coupled to the stopper 510. The third portion 533 may provide axial movement to the first portion 531 by having a length in the directions 503 and 504 that are a moving direction of the sliding member 530. The axial movement of the sliding member 530 through the second portion 532 of the sliding member 530 by the rotation of the third housing part 230 with respect to the second housing part 220 will be described below. By including the sliding member 530 for moving the stopper 510 while the state of the electronic device 101 changes, the electronic device 101 may be configured to provide a variety of user experiences to the user and support the second housing part 220 and the third housing part 230 through the stopper 510 in the first state 101a.

The stopper 510 may include a guide hole 512. The first portion 531 of the sliding member 530 may include a coupling hole 531a. The electronic device 101 may further include a coupling pin 540 penetrating the guide hole 512 and the coupling hole 531a such that the first portion 531 is slidably coupled to the stopper 510. For example, with reference to FIGS. 5D and 5E, the first portion 531 of the sliding member 530 may be disposed between the guide holes 512 of the stopper 510. The coupling pin 540 may slidably couple the first portion 531 to the stopper 510 by penetrating the guide hole 512 and the coupling hole 531a of the first portion 531. For example, the electronic device 101 may include a fixing pin 550 for preventing separation of the coupling pin 540 from the first portion 531 and the stopper 510. The fixing pin 550 may be fastened to an end portion of the coupling pin 540.

For example, with reference to FIGS. 5A and 5B, the first portion 531 of the sliding member 530 may be slidably coupled to the guide hole 512 of the stopper 510 in directions 505 and 506 through the coupling pin 540.

For example, while the electronic device 101 changes from the second state 101b to the first state 101a, the sliding member 530 may slide in the direction 503 with respect to the second hinge cover 420. The coupling pin 540 may be moved in the direction 505 along the guide hole 512 by the first portion 531 of the sliding member 530 slid in the direction 503. As the stopper 510 is pushed by the coupling pin 540 moving in the direction 505, the stopper 510 may be moved in the direction 501 along the guide rail 521. The stopper 510 may protrude from the outer surface 425 of the second hinge cover 420 by moving in the direction 501.

For example, while the electronic device 101 changes from the first state 101a to the second state 101b, the sliding member 530 may slide in the direction 504 with respect to the second hinge cover 420. The coupling pin 540 may be moved in the direction 506 along the guide hole 512 by the first portion 531 of the sliding member 530 slid in the direction 504. As the stopper 510 is pulled by the coupling pin 540 moving in the direction 506, the stopper 510 may be moved in the direction 502 along the guide rail 521. The stopper 510 may be disposed in the through hole 520 to form the continuous surface with the outer surface 425 of the second hinge cover 420 by moving in the direction 502. However, embodiments of the present disclosure are not limited thereto.

Example configurations of the electronic device 101 for moving the stopper 510 through the rotation of the third housing part 230 with respect to the second housing part 220 are described below.

FIGS. 6A and 6B illustrate a second hinge assembly and a second hinge cover of an electronic device. FIG. 6C illustrates a portion of an electronic device in a first state. FIG. 6D illustrates a portion of an electronic device in a second state. FIG. 6E illustrates a portion of an electronic device in a first state. FIG. 6F illustrates a portion of an electronic device in a second state.

Referring to FIGS. 6A, 6B, 6C, 6D, 6E, and 6F, an electronic device 101 may include a housing 200 including a first housing part 210, a second housing part 220, and a third housing part 230. The electronic device 101 may include a first hinge assembly (e.g., the first hinge assembly 250 of FIG. 3A) rotatably coupling the first housing part 210 and the second housing part 220. The electronic device 101 may include a second hinge assembly 260 rotatably coupling the second housing part 220 and the third housing part 230. The second housing part 220 and the third housing part 230 may be spaced apart from each other in a first state 101a of the electronic device 101. The electronic device 101 may include a stopper 510 positioned between the second housing part 220 and the third housing part 230 to support the second housing part 220 and the third housing part 230 in the first state 101a of the electronic device 101. However, embodiments of the present disclosure are not limited thereto, and for example, the electronic device 101 illustrated in and described with reference to FIGS. 6A to 6F may include structures and/or configurations illustrated in and described with reference to FIGS. 2A to 5G. Additionally, hereinafter, an overlapping description of structures and/or configurations that have the same reference numerals as the structures and/or the configurations illustrated in and described with reference to FIGS. 2A to 5G may be omitted.

Referring to FIGS. 6A and 6B, hinge portions (e.g., the first hinge portion 260a, the second hinge portion 260b, and the third hinge portion 260c) of the second hinge assembly 260 are illustrated as an example. Each of the hinge portions (e.g., the first hinge portion 260a, the second hinge portion 260b, and the third hinge portion 260c) may be referred to as any one of a hinge, a hinge module, and a hinge structure for rotatably coupling the second housing part 220 and the third housing part 230. For example, the first hinge portion 260a and the second hinge portion 260b may be disposed at longitudinal end portions of a second hinge cover 420 (or the second hinge assembly 260). For example, the third hinge portion 260c may be positioned between the first hinge portion 260a and the second hinge portion 260b. The third hinge portion 260c may be, for example, linked to the second hinge portion 260b by being disposed adjacent to the second hinge portion 260b. The third hinge portion 260c may be spaced apart from the first hinge portion 260a. For example, an electronic component (e.g., a flexible printed circuit board) of the electronic devices 101 may cross or be disposed through a gap between the third hinge portion 260c and the first hinge portion 260a. However, it should be noted that embodiments of the present disclosure are not limited thereto, and the second hinge assembly 260 may include a plurality of hinge portions including the first hinge portion 260a, the second hinge portion 260b, and the third hinge portion 260c, and is not intended to limit a disposition relationship between them. Furthermore, detailed structures of the second hinge assembly 260 to be described below, may be included in any of the hinge portions (e.g., the first hinge portion 260a, the second hinge portion 260b, and the third hinge portion 260c), or may be included all of the hinge portions (e.g., the first hinge portion 260a, the second hinge portion 260b, and the third hinge portion 260c), respectively. For example, as illustrated, stoppers 510 may be linked to the first hinge portion 260a and the second hinge portion 260b, respectively, by being disposed at the longitudinal end portions of the second hinge cover 420. However, embodiments of the present disclosure are not limited thereto. Hereinafter, an structure of the second hinge assembly 260 for moving the stopper 510 is described.

Referring to FIGS. 6C, 6D, 6E, and 6F, a sliding member 530 may include a first portion (e.g., the first portion 531 of FIG. 5D) coupled to the stopper 510, a second portion 532 configured to slide by rotation of the third housing part 230 with respect to the second housing part 220, and a third portion 533 extending from the first portion 531 to the second portion 532 and providing a driving force for moving the stopper 510 through the second portion 532.

The second hinge assembly 260 may include at least one hinge plate 610 rotatably connecting the second housing part 220 and the third housing part 230. The at least one hinge plate 610 may include a first hinge plate 611 coupled to the second housing part 220, and a second hinge plate 612 coupled to the third housing part 230. The second housing part 220 may include a first plate 621 coupled to the first hinge plate 611 to rotate together with the first hinge plate 611. The third housing part 230 may include a second plate 622 coupled to the second hinge plate 612 to rotate together with the second hinge plate 612.

For example, the first hinge plate 611 may rotatably couple the second hinge assembly 260 and the second housing part 220. The second hinge plate 612 may rotatably couple the second hinge assembly 260 and the third housing part 230. Through the first hinge plate 611 and the second hinge plate 612, the third housing part 230 may rotate with respect to the second housing part 220 based on the second hinge assembly 260 (or the second hinge cover 420). For example, the first plate 621 may be a portion of the second housing part 220 that is coupled to the second hinge assembly 260 (or the first hinge plate 611). The second plate 622 may be a portion of the third housing part 230 that is coupled to the second hinge assembly 260 (or the second hinge plate 612). For example, according to some embodiments, the first hinge plate 611 may be rotatably coupled to the first plate 621 through a shaft. The second hinge plate 612 may be rotatably coupled to the second plate 622 through the shaft. As the first hinge plate 611 is rotatably coupled to the first plate 621, a rotation axis of the first hinge plate 611 may be offset with respect to a rotation axis of the first plate 621. As the second hinge plate 612 is rotatably coupled to the second plate 622, a rotation axis of the second hinge plate 612 may be offset with respect to a rotation axis of the second plate 622. However, embodiments of the present disclosure are not limited thereto.

The first plate 621 may include a first spiral portion 621a. The second plate 622 may include a second spiral portion 622a. The second portion 532 of the sliding member 530 may include a first slide portion 532a slidably coupled to the first spiral portion 621a and having a spiral shape corresponding to the first spiral portion 621a to provide axial movement of the third portion 533 of the sliding member 530 through rotation of the first plate 621, and a second slide portion 532b slidably coupled to the second spiral portion 622a and having a spiral shape corresponding to the second spiral portion 622a to provide axial movement of the third portion 533 of the sliding member 530 through rotation of the second plate 622.

For example, the first spiral portion 621a and the second spiral portion 622a may be portions of the housing 200 for axial moving of the sliding member 530 in directions 503 and 504 through rotation of the housing parts (e.g., the second housing part 220 and the third housing part 230) by rotation of the hinge plate 610. For example, the first spiral portion 621a and the second spiral portion 622a may be disposed to face each other. For example, the second portion 532 of the sliding member 530 may be a portion of the sliding member 530 that is coupled to the second housing part 220 and the third housing part 230. For example, the first slide portion 532a of the second portion 532 may be rotatably coupled to the first spiral portion 621a so as to be slidable along a spiral path formed by the first spiral portion 621a of the first plate 621. The second slide portion 532b of the second portion 532 may be rotatably coupled to the second spiral portion 622a so as to be slidable along a spiral path formed by the second spiral portion 622a of the second plate 622.

For example, while the electronic device 101 changes from the first state 101a to a second state 101b, the first hinge plate 611 and the first plate 621 coupled to the first hinge plate 611 may be rotated in a rotation direction 601. The second hinge plate 612 and the second plate 622 coupled to the second hinge plate 612 may be rotated in a rotation direction 602 opposite to the rotation direction 601. The first spiral portion 621a may be rotated in the rotation direction 601 along the first plate 621. The first slide portion 532a of the sliding member 530 that is slidably engaged with the first spiral portion 621a may move the sliding member 530 in the direction 504 by being pressed by rotation of the first spiral portion 621a in the rotation direction 601. The second spiral portion 622a may be rotated in the rotation direction 602 along the second plate 622. The second slide portion 532b of the sliding member 530 that is slidably engaged with the second spiral portion 622a may move the sliding member 530 in the direction 504 by being pressed by rotation of the second spiral portion 622a in the rotation direction 602. As the sliding member 530 moves in the direction 504, a gap g between the second portion 532 of the sliding member 530 and a hinge bracket 630 may be formed. However, embodiments of the present disclosure are not limited thereto.

For example, while the electronic device 101 changes from the second state 101b to the first state 101a, the first hinge plate 611 and the first plate 621 coupled to the first hinge plate 611 may be rotated in the rotation direction 602. The second hinge plate 612 and the second plate 622 coupled to the second hinge plate 612 may be rotated in the rotation direction 601 opposite to the rotation direction 602. The first spiral portion 621a may be rotated in the rotation direction 602 along the first plate 621. The first slide portion 532a of the sliding member 530 that is slidably engaged with the first spiral portion 621a may move the sliding member 530 in the direction 503 by being pushed by the rotation of the first spiral portion 621a in the rotation direction 601. The second spiral portion 622a may be rotated in the rotation direction 601 along the second plate 622. The second slide portion 532b of the sliding member 530 that is slidably engaged with the second spiral portion 622a may move the sliding member 530 in the direction 503 by being pushed by the rotation of the second spiral portion 622a in the rotation direction 601. However, embodiments of the present disclosure are not limited thereto. The electronic device 101 may be configured to move the stopper 510 coupled to the sliding member 530 while the state of the electronic device 101 is changed by including the sliding member 530 configured to axial move through rotation of the second housing part 220 and the third housing part 230.

The electronic device 101 may include a plurality of engagement protrusions 640 for guiding the first state 101a and the second state 101b of the electronic device 101, and a plurality of elastic members 660 configured to press the plurality of engagement protrusions 640. For example, the first plate 621 of the second housing part 220 may include first engagement protrusions 641. The second plate 622 of the third housing part 230 may include second engagement protrusions 642. The electronic device 101 may include a first engagement portion 651 including third engagement protrusions 643 engaged with the first engagement protrusions 641 of the first plate 621, a second engagement portion 652 including fourth engagement protrusions 644 engaged with the second engagement protrusions 642 of the second plate 622, and a guiding member 650 including a connecting portion 653 extending from the first engagement portion 651 to the second engagement portion 652. For example, the plurality of elastic members 660 may include a first elastic member 661 that provides an elastic support to the first engagement portion 651 of the guiding member 650 such that the third engagement protrusions 643 are engaged with the first engagement protrusions 641, and a second elastic member 662 that provides an elastic support to the second engagement portion 652 of the guiding member 650 such that the fourth engagement protrusions 644 are engaged with the second engagement protrusions 642.

For example, the guiding member 650 may be engaged with the first plate 621 and the second plate 622 on the second hinge cover 420, respectively. The first engagement portion 651 and the second engagement portion 652 of the guiding member 650 may form opposite ends of the guiding member 650. For example, the first engagement protrusions 641 and the third engagement protrusions 643 may provide the housing 200 with a locking force to maintain the first state 101a and the second state 101b by engaging or contacting each other in the first state 101a and the second state 101b of the electronic device 101. The second engagement protrusions 642 and the fourth engagement protrusions 644 may provide the housing 200 with a locking force to maintain the first state 101a and the second state 101b of the electronic device 101 by engaging or contacting each other in the first state 101a and the second state 101b of the electronic device 101.

For example, the first elastic member 661 may provide a locking force between the third protrusions (e.g., the third engagement protrusions 643) and the first protrusions (e.g., the first engagement protrusions 641) by providing a repulsive force in the direction 503 to the first engagement portion 651 of the guiding member 650. The second elastic member 662 may provide a locking force between the fourth protrusions (e.g., the fourth engagement protrusions 644) and the second protrusions (e.g., the second engagement protrusions 642) by providing a repulsive force in the direction 502 to the second engagement portion 652 of the guiding member 650. For example, the first elastic member 661 and the second elastic member 662 may guide a change in the state of the electronic device 101 by each being configured to be movable or deformable in the directions 503 and 504. However, embodiments of the present disclosure are not limited thereto.

The second hinge assembly 260 may include a hinge bracket 630 that includes a guide recess 635 accommodating the third portion 533 of the sliding member 530 and guiding moving of the third portion 533 in the direction 503 and the direction 504 opposite to the direction 503 that are corresponding to longitudinal directions of the third portion 533. For example, the hinge bracket 630 may be coupled on the second hinge cover 420. For example, the hinge bracket 630 may be rotatably coupled to the first hinge plate 611 and the second hinge plate 612. For example, the hinge bracket 630 may provide seating portions for components disposed on the second hinge cover 420. For example, the guide recess 635 may have a length in the directions 503 and 504 to guide sliding in the directions 503 and 504 of the third portion 533 of the sliding member 530. For example, the guide recess 635 may have a shape corresponding to a shape of the third portion 533 to guide moving of the third portion 533 of the sliding member 530. An example structure of the guide recess 635 and/or the hinge bracket 630 for preventing separation of the third portion 533 is described below.

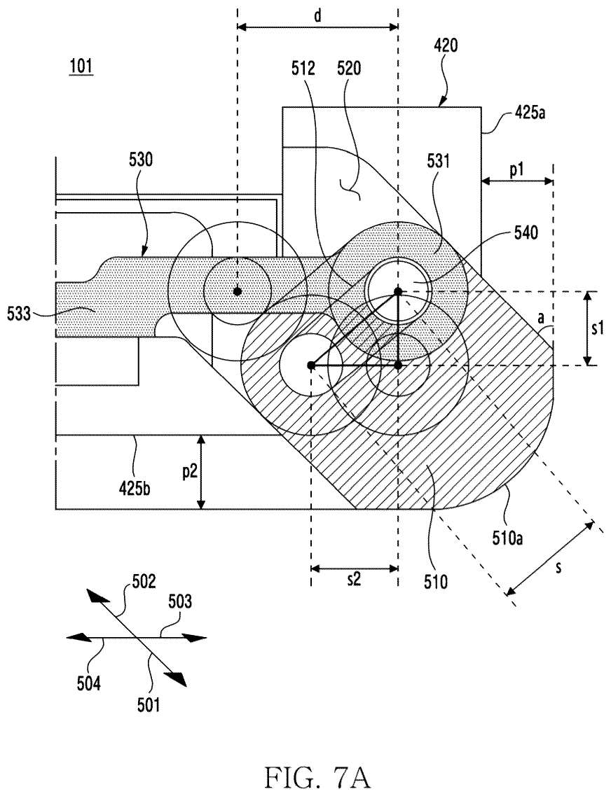

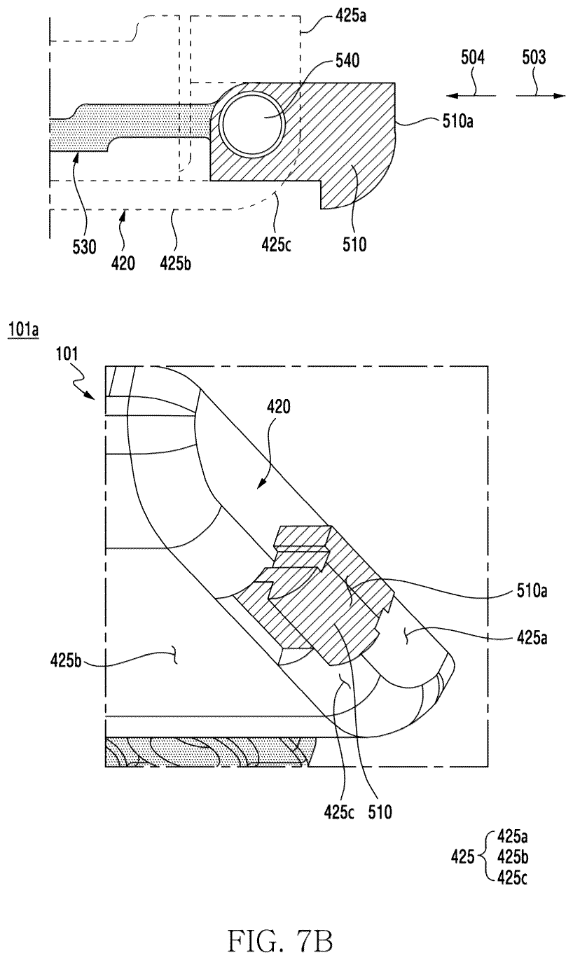

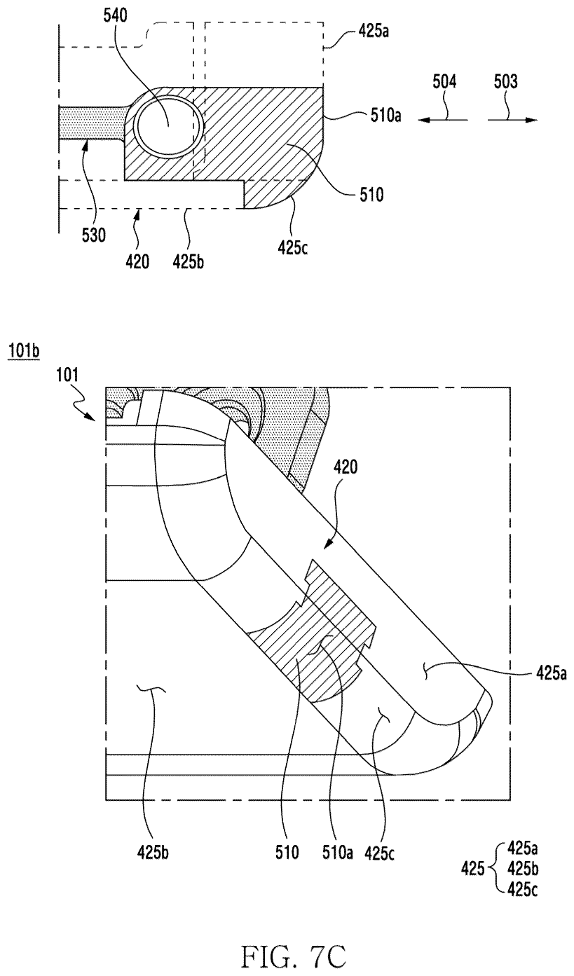

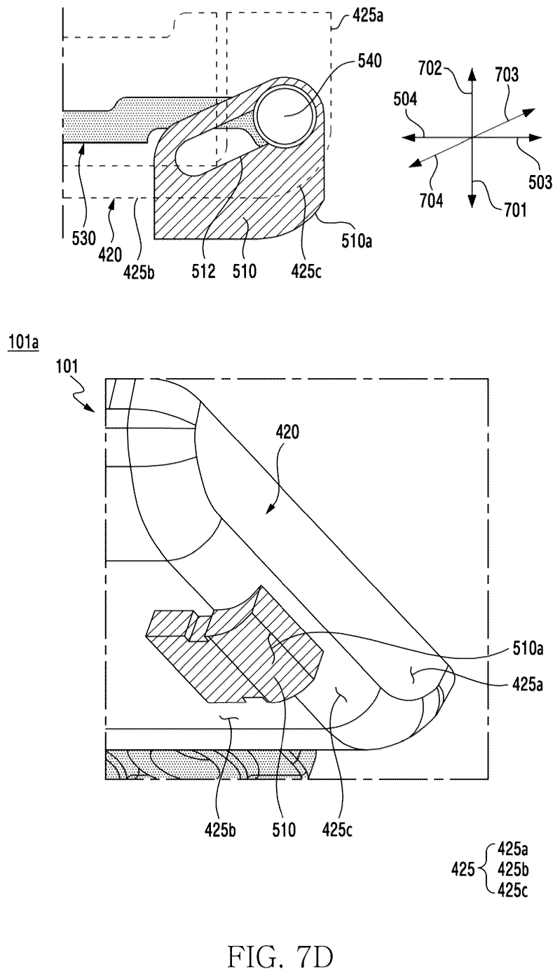

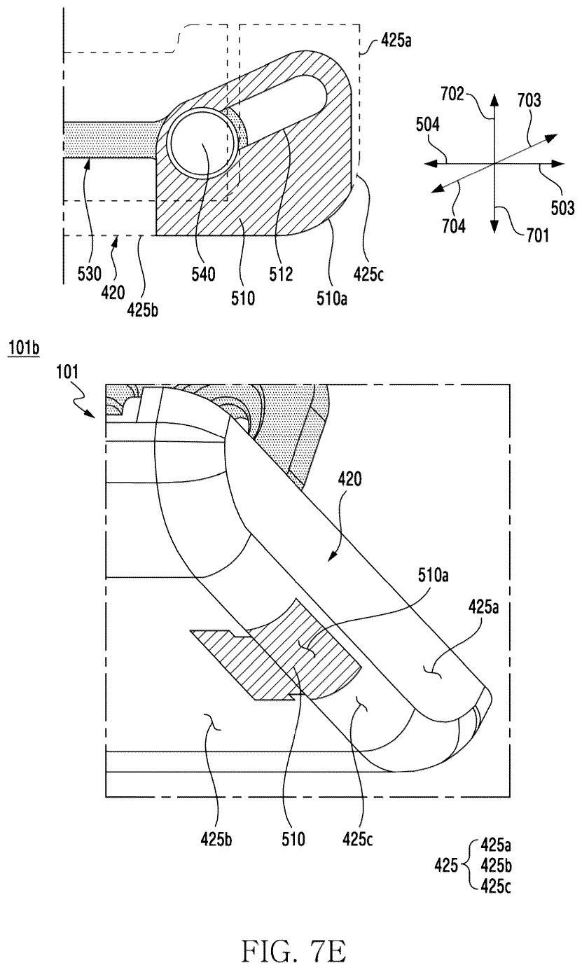

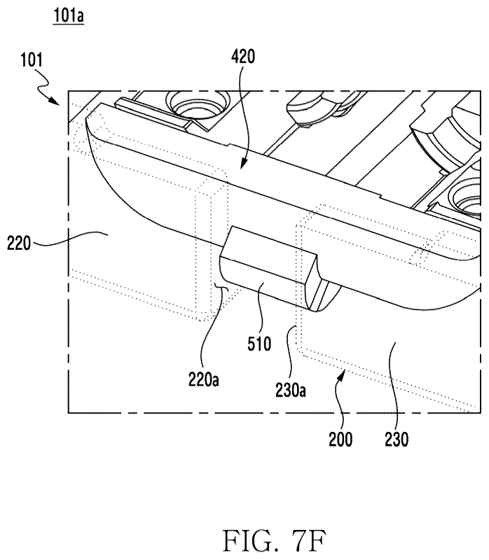

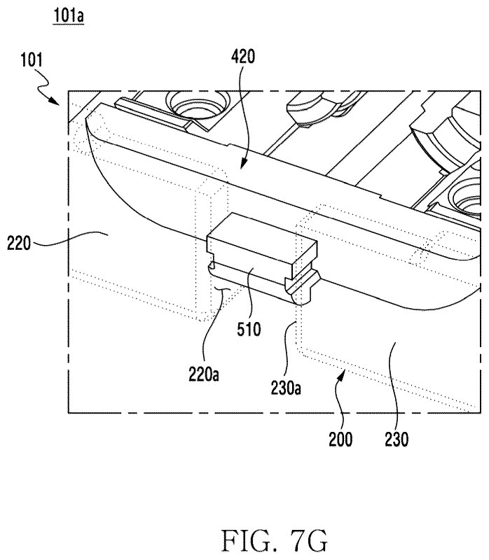

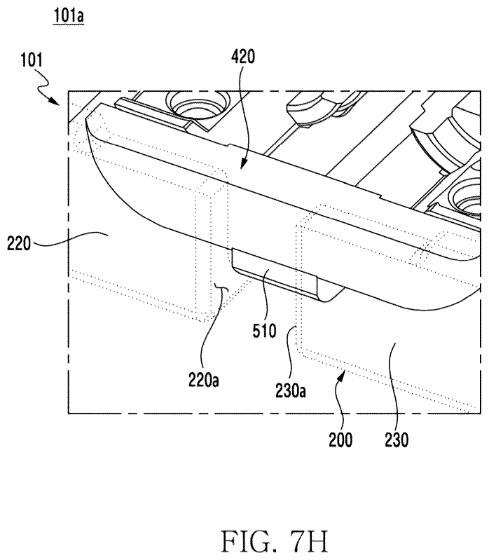

FIG. 7A illustrates a structure for movement of a stopper of an electronic device. FIG. 7B illustrates a portion of an electronic device in a first state. FIG. 7C illustrates a portion of an electronic device in a second state. FIG. 7D illustrates a portion of an electronic device in a first state. FIG. 7E illustrates a portion of an electronic device in a second state. FIGS. 7F, 7G, and 7H illustrate a portion of an electronic device in an first state.

Referring to FIGS. 7A, 7B, 7C, 7D, 7E, 7F, 7G, and 7H, an electronic device 101 may include a housing 200 including a first housing part 210, a second housing part 220, and a third housing part 230. The electronic device 101 may include a first hinge assembly (e.g., the first hinge assembly 250 of FIG. 3A) rotatably coupling the first housing part 210 and the second housing part 220. The electronic device 101 may include a second hinge assembly 260 rotatably coupling the second housing part 220 and the third housing part 230. The second housing part 220 and the third housing part 230 may be spaced apart from each other in a first state 101a of the electronic device 101. The electronic device 101 may include a stopper 510 positioned between the second housing part 220 and the third housing part 230 to support the second housing part 220 and the third housing part 230 in the first state 101a of the electronic device 101. However, embodiments of the present disclosure are not limited thereto, and for example, the electronic device 101 illustrated in and described with reference to FIGS. 7A to 7H may include structures and/or configurations illustrated in and described with reference to FIGS. 2A to 6F. Additionally, hereinafter, an overlapping description of structures and/or configurations that have the same reference numerals as the structures and/or the configurations illustrated in and described with reference to FIGS. 2A to 6F may be omitted.

Referring to FIG. 7A, an example of the stopper 510 slidably coupled to a through hole 520 of a second hinge cover 420 is illustrated. A direction in which the stopper 510 protrudes from an outer surface 425 of the second hinge cover 420 may be determined or designed by values illustrated in FIG. 7A, as an example.

For example, a horizontal distance s2 in which a coupling pin 540 is movable along a guide hole 512 may be determined through the following Equation 1 for a movable distance d of the sliding member 530 (or the third portion 533 of the sliding member 530) and a movable horizontal distance p1 of the stopper 510.

s2=d−p1 [Equation 1]

For example, a vertical distance s1 in which the coupling pin 540 is movable along the guide hole 512 may correspond to a movable vertical distance p2 of the stopper 510. In addition, an angle a between a moving direction of the stopper 510 and a vertical surface 425a of the second hinge cover 420 may be determined through the following Equation 2.

a=arctangent(p1/p2) [Equation 2]

A protruding amount and/or a protruding direction of the stopper 510 in the first state 101a of the electronic device 101 may be determined or designed using Equation 1 and Equation 2. Hereinafter, examples of the stopper 510 that may protrude in various directions are described.

Referring to FIGS. 7B and 7C, unlike FIG. 7A, the stopper 510 may be movable in a direction corresponding to the vertical surface 425a of the second hinge cover 420. For example, the stopper 510 may be movably coupled to the second hinge cover 420 in directions 503 and 504 that are moving directions of the sliding member 530. For example, the through hole 520 for protruding the stopper 510 may be formed in a portion of the vertical surface 425a and a portion of a curved surface 425c of the outer surface 425 of the second hinge cover 420. In this case, since the moving direction of the stopper 510 corresponds to (e.g., is the same as) the moving direction of the sliding member 530, the guide hole 512 of the stopper 510 may be omitted.

Referring to FIGS. 7E and 7F, unlike FIG. 7A, the stopper 510 may be movable in a direction corresponding to a horizontal surface 425b of the second hinge cover 420. For example, the stopper 510 may be movably coupled to the second hinge cover 420 in directions 701 and 702, which are directions parallel to a direction in which the horizontal surface 425b faces. For example, the through hole 520 for protruding the stopper 510 may be formed in a portion of the horizontal surface 425b and a portion of the curved surface 425c of the outer surface 425 of the second hinge cover 420. For example, while the electronic device 101 changes from the first state 101a to a second state 101b, the coupling pin 540 may move in a direction 704 along the sliding member 530 that moves in the direction 504. By being pulled by the coupling pin 540 moving in the direction 704, the stopper 510 may be moved in the direction 702. For example, while the electronic device 101 changes from the second state 101b to the first state 101a, the coupling pin 540 may move in a direction 703 along the sliding member 530 that moves in the direction 503. By being pushed by the coupling pin 540 moving in the direction 703, the stopper 510 may be moved in the direction 701. However, embodiments of the present disclosure are not limited thereto, and, through the equations described above with reference to FIG. 7A, the stopper 510 may protrude from the second hinge cover 420 in various directions to be positioned between the second housing part 220 and the third housing part 230 in the first state 101a of the electronic device 101, as illustrated in FIG. 7F, FIG. 7G, and FIG. 7H as examples.

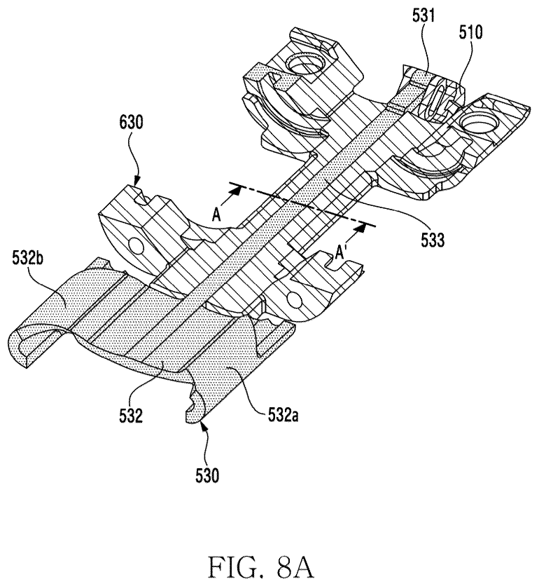

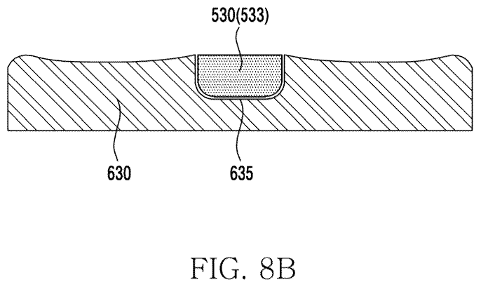

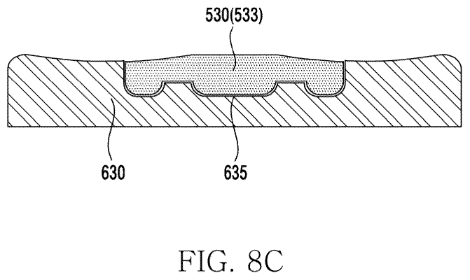

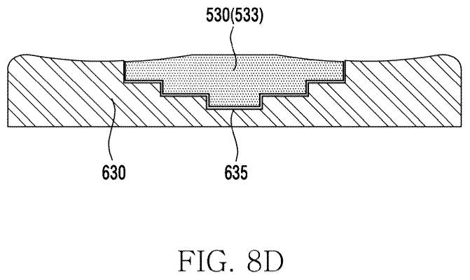

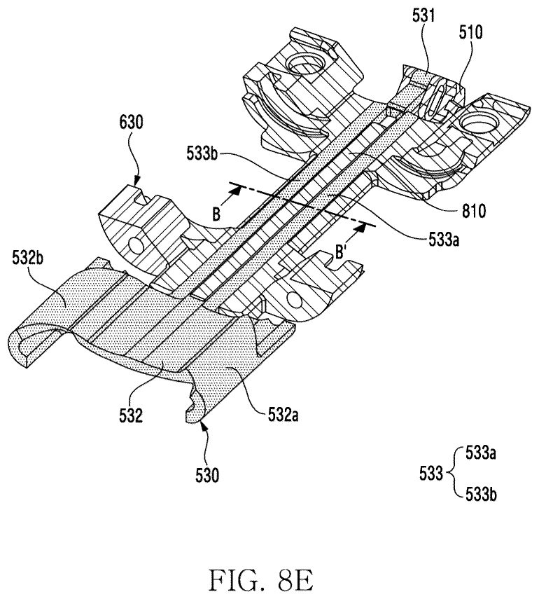

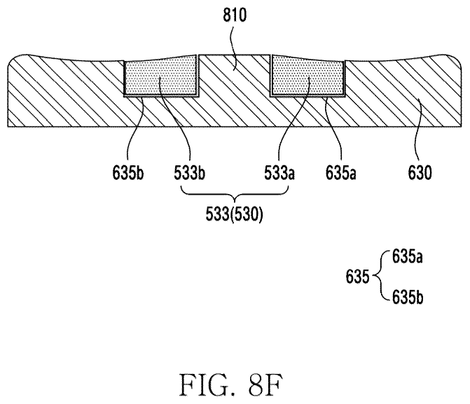

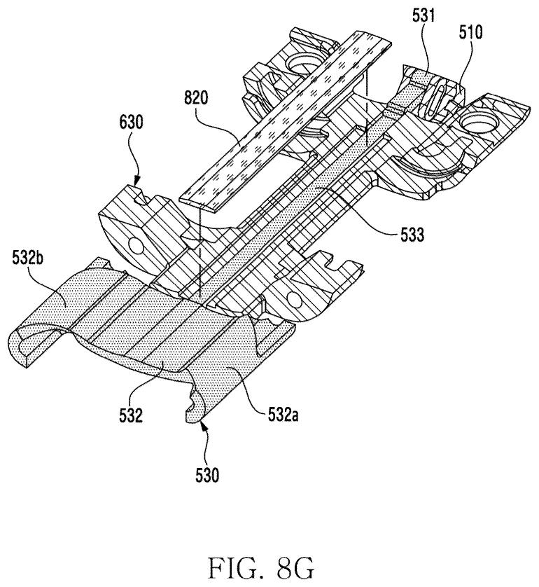

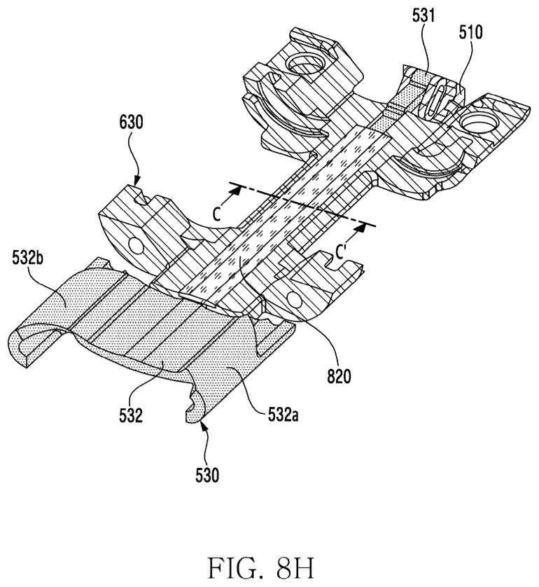

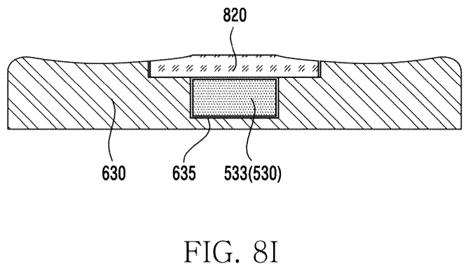

FIG. 8A illustrates a hinge bracket and a sliding member of an electronic device. FIGS. 8B, 8C, and 8D are cross-sectional views of an hinge bracket and a sliding member cut along a line A-A′ of FIG. 8A. FIG. 8E illustrates a hinge bracket and a sliding member of an electronic device. FIG. 8F is a cross-sectional view of an hinge bracket and a sliding member cut along a line B-B′ of FIG. 8E. FIGS. 8G and 8H illustrate a hinge bracket, a sliding member, and a fastening cover of an electronic device. FIG. 8I is a cross-sectional view of an hinge bracket, a sliding member, and a fastening cover cut along a line C-C′ of FIG. 8H.

Referring to FIG. 8A, FIG. 8B, FIG. 8C, FIG. 8D, FIG. 8E, FIG. 8F, FIG. 8G, FIG. 8H, and FIG. 8I, a sliding member 530 and a hinge bracket 630 disposed in the electronic device 101 illustrated and described in FIG. 6A to FIG. 6F are exemplarily illustrated. The sliding member 530 may include a first portion 531 coupled to a stopper 510, a second portion 532 configured to slide by rotation of a third housing part (e.g., the third housing part 230 of FIG. 2A) with respect to a second housing part (e.g., the second housing part 220 of FIG. 2A), and a third portion 533 extending from the first portion 531 to the second portion 532 and providing a driving force for moving the stopper 510 through the second portion 532. The hinge bracket 630 may include a guide recess 635 that accommodates the third portion 533 of the sliding member 530 and guides moving of the third portion 533 in a longitudinal direction of the third portion 533. The second portion 532 may include a first slide portion 532a and a second slide portion 532b having a spiral shape for converting rotation of the second housing part 220 and the third housing part 230 with respect to a second hinge cover (e.g., the second hinge cover 420 of the FIG. 4A) into axial moving of the third portion 533 by being respectively linked to the second housing part 220 and the third housing part 230.

Referring to FIGS. 8A and 8B, the guide recess 635 of the hinge bracket 630 may have a shape corresponding to the third portion 533 such that the third portion 533 of the sliding member 530 is slidable in the guide recess 635. For example, in a comparative embodiment, while the third portion 533 slides in the guide recess 635, the third portion 533 may be at least partially separated from the guide recess 635. In the electronic device 101, a structure for preventing separation of the third portion 533 from the guide recess 635 while a state of the electronic device 101 changes may be provided as discussed below.

Referring to FIGS. 8C and 8D, when compared to FIG. 8B, the guide recess 635 and the third portion 533 accommodated in the guide recess 635 may include a structure for increasing an area in contact with each other. For example, with reference to FIG. 8C, the guide recess 635 may include protruding portions protruding from an inner surface of the guide recess 635. The third portion 533 may include recess structures accommodating the protrusions and having a shape corresponding to the protrusions. For example, with reference to FIG. 8D, the guide recess 635 may have a stepped structure. The third portion 533 accommodated in the guide recess 635 may include step portions corresponding to a shape of the guide recess 635 (e.g., a stepped guide recess). However, embodiments of the present disclosure are not limited thereto, and the guide recess 635 and the third portion 533 accommodated in the guide recess 635 may reduce the separation of the third portion 533 from the guide recess 635 by including various structures to increase a contact area with each other.

Referring to FIGS. 8E and 8F, the third portion 533 of the sliding member 530 may include a first shaft portion 533a and a second shaft portion 533b spaced apart from the first shaft portion 533a. The guide recess 635 of the hinge bracket 630 may include a first recess 635a accommodating the first shaft portion 533a, and a second recess 635b accommodating the second shaft portion 533b. The hinge bracket 630 may include a protrusion 810 separating the first recess 635a and the second recess 635b and disposed between the first shaft portion 533a and the second shaft portion 533b. For example, the protrusion 810 may separate the first shaft portion 533a and the second shaft portion 533b. By contacting the first shaft portion 533a and the second shaft portion 533b, the protrusion 810 may increase a contact area between the third portion 533 and the hinge bracket 630. However, embodiments of the present disclosure are not limited thereto, and the third portion 533 may include a plurality of shaft portions spaced apart from each other. The hinge bracket 630 may include a plurality of recesses corresponding to each of the plurality of shaft portions, and a plurality of protrusions disposed between the plurality of recesses.

Referring to FIGS. 8G, 8H, and 8I, a second hinge assembly 260 may include a fastening cover 820 coupled to the hinge bracket 630 to prevent the third portion 533 of the sliding member 530 from being separated from the guide recess 635 of the hinge bracket 630. For example, the fastening cover 820 may at least partially cover the third portion 533 by being disposed on the hinge bracket 630. For example, the fastening cover 820 may restrict moving of the third portion 533 outside the guide recess 635 by being fastened on the hinge bracket 630. However, embodiments of the present disclosure are not limited thereto.

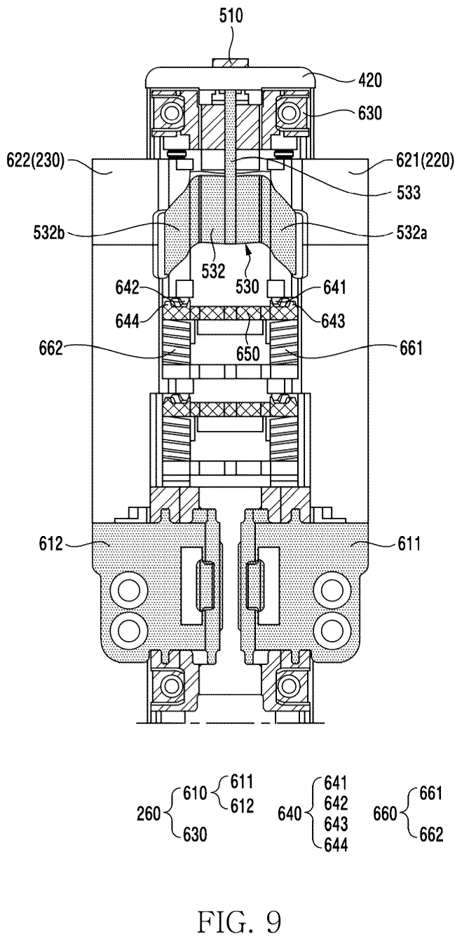

FIG. 9 illustrates a portion of an electronic device in a first state.

Referring to FIG. 9, an electronic device 101 may include a housing (e.g., the housing 200 of FIG. 2A) including a first housing part (e.g., the first housing part 210 of FIG. 2A), a second housing part (e.g., the second housing part 220 of FIG. 2A), and a third housing part (e.g., the third housing part 230 of FIG. 2A). The electronic device 101 may include a first hinge assembly (e.g., the first hinge assembly 250 of FIG. 3A) rotatably coupling the first housing part 210 and the second housing part 220. The electronic device 101 may include a second hinge assembly 260 rotatably coupling the second housing part 220 and the third housing part 230. The second housing part 220 and the third housing part 230 may be spaced apart from each other in a first state 101a of the electronic device 101. The electronic device 101 may include a stopper 510 positioned between the second housing part 220 and the third housing part 230 to support the second housing part 220 and the third housing part 230 in the first state 101a of the electronic device 101. However, embodiments of the present disclosure are not limited thereto, and for example, the electronic device 101 illustrated in and described with reference to FIG. 9 may include structures and/or configurations illustrated in and described with reference to FIG. 2A to 8I. Additionally, hereinafter, an overlapping description of structures and/or configurations that have the same reference numerals as the structures and/or the configurations illustrated in and described with reference to FIGS. 2A to 8I may be omitted.

Referring to FIG. 9, when compared to FIG. 6C, a second portion 532 of a sliding member 530 may be disposed more adjacent to the stopper 510 (or an end portion of a second hinge cover 420). For example, unlike in FIG. 7C, a first plate 621 and a second plate 622 that are slidably coupled to the second portion 532 of the sliding member 530 may be disposed more adjacent to the stopper 510 than to a first hinge plate 611 and a second hinge plate 612. As the second portion 532 is disposed adjacent to the stopper 510, a length of the third portion 533 for connecting a first portion 531 coupled to the stopper 510 and the second portion 532 may be relatively shorter when compared to FIG. 6C. For example, a length of a guide recess 635 of a hinge bracket 630 to accommodate the third portion 533 may also be shortened as the length of the third portion 533 is shortened. As the length of the third portion 533 is shortened, the electronic device 101 may reduce separation of the third portion 533 from the guide recess 635 while a state of the electronic device 101 changes.

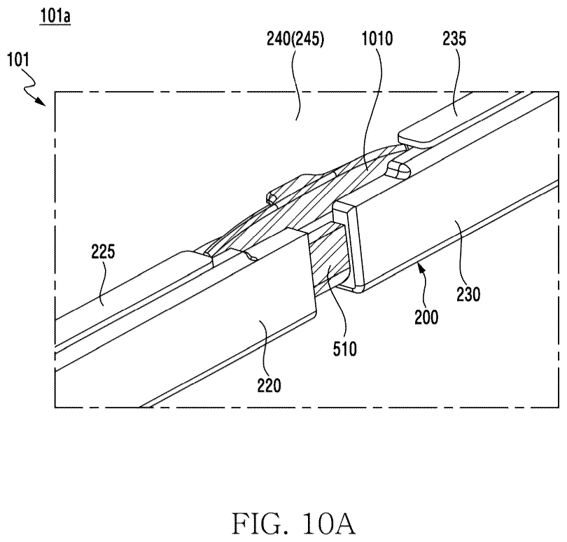

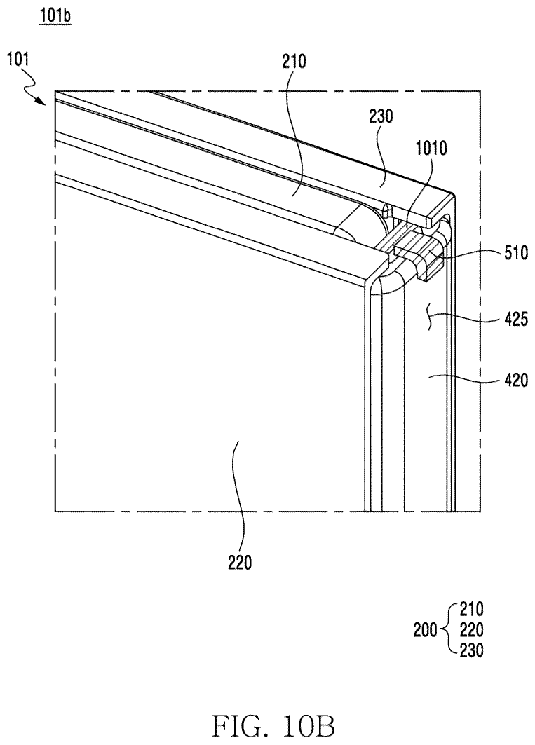

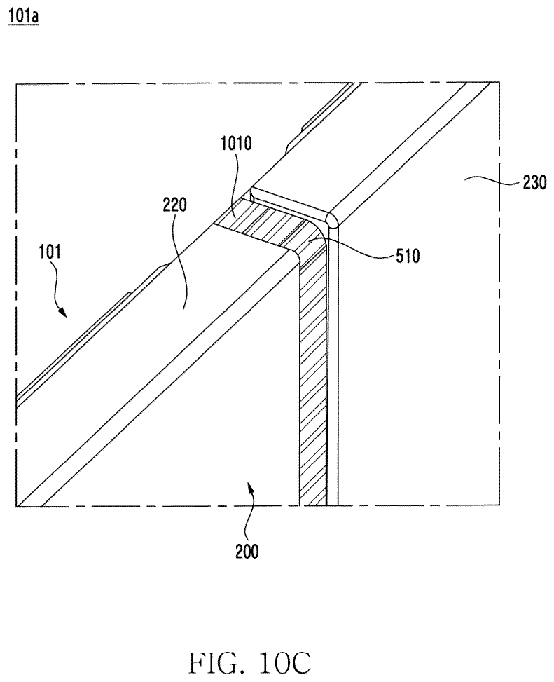

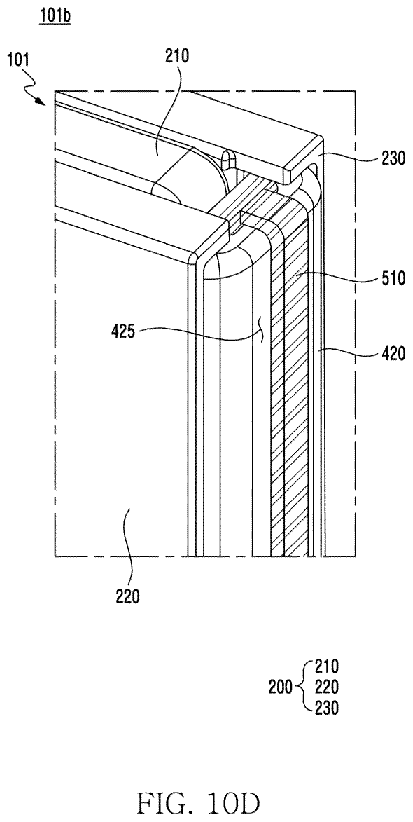

FIG. 10A illustrates a portion of an electronic device in a first state. FIG. 10B illustrates a portion of an electronic device in a second state. FIG. 10C illustrates a portion of an electronic device in a first state. FIG. 10D illustrates a portion of an electronic device in a second state.

Referring to FIGS. 10A, 10B, 10C, and 10D, an electronic device 101 may include a housing 200 including a first housing part 210, a second housing part 220, and a third housing part 230. The electronic device 101 may include a first hinge assembly (e.g., the first hinge assembly 250 of FIG. 3A) rotatably coupling the first housing part 210 and the second housing part 220. The electronic device 101 may include a second hinge assembly (e.g., the second hinge assembly 260 of FIG. 3A) rotatably coupling the second housing part 220 and the third housing part 230. The second housing part 220 and the third housing part 230 may be spaced apart from each other in a first state 101a of the electronic device 101. The electronic device 101 may include a stopper 510 positioned between the second housing part 220 and the third housing part 230 to support the second housing part 220 and the third housing part 230 in the first state 101a of the electronic device 101.

Unlike the stopper 510 illustrated in and described with reference to FIGS. 5A to 9, referring to FIGS. 10A to 10D, the stopper 510 may be provided as a portion of a second hinge cover 420, or a position of the stopper 510 may be fixed with respect to the second hinge cover 420. For example, the stopper 510 may be a structure protruding from an outer surface 425 of the second hinge cover 420. The position of the stopper 510 may be fixed regardless of a state change of the electronic device 101. For example, with reference to FIGS. 5A and 5B, the stopper 510 may be a structure having a shape protruding at an end portion of the second hinge cover 420. For example, with reference to FIGS. 5C and 5D, the stopper 510 may be a structure formed across a horizontal surface (e.g., the horizontal surface 425b of FIG. 5A) of the second hinge cover 420 to increase a contact area with the housing parts (e.g., the second housing part 220 and the third housing part 230). However, embodiments of the present disclosure are not limited thereto.

For example, the electronic device 101 may include a protective member 1010 disposed above a longitudinal end portion of the second hinge cover 420 to protect a fifth display portion 245 of a flexible display 240. The stopper 510 may be integrally formed with the protective member 1010, or may be disposed adjacent to the protective member 1010. However, embodiments of the present disclosure are not limited thereto.

Technical problems by embodiments of the present disclosure are not limited to those mentioned above, and other technical problems not mentioned, that are solved by embodiments of the present disclosure, will be clearly understood by those having ordinary knowledge in the art to which the present disclosure belongs.

As described above, a multi-foldable electronic device (e.g., the electronic device 101 of FIG. 1) may comprise a housing (e.g., the housing 200 of FIG. 2A) including a first housing part (e.g., the first housing part 210), a second housing part (e.g., the second housing part 220), and a third housing part (e.g., the third housing part 230 of FIG. 2A). The multi-foldable electronic device may include a first hinge assembly (e.g., the first hinge assembly 250 of FIG. 3A) rotatably coupling the first housing part and the second housing part, a second hinge assembly (e.g., the second hinge assembly 260 of FIG. 3A), rotatably coupling the second housing part and the third housing part, including a sliding member (e.g., the sliding member 530 of FIG. 5A) including a first sink arm (e.g., the first slide portion 532a of FIG. 6C) and a second sink arm (e.g., the second slide portion 532b of FIG. 6C) and slid in accordance with engagement of a spiral surface of the first sink arm, engagement of a spiral surface of the second sink arm, and rotation of the third housing part with respect to the second housing part. The multi-foldable electronic device may include a stopper (e.g., the stopper 510 of FIG. 5A) coupled to the sliding member to be movable in accordance with the rotation of the third housing part with respect to the second housing part. The second housing part and the third housing part may be spaced apart from each other in an unfolded state (e.g., the first state 101a of FIG. 2A) of the multi-fold electronic device. The stopper may be configured to be positioned between the second housing part and the third housing part to support the second housing part and the third housing part in the unfolded state (e.g., the first state 101a of FIG. 2A) of the multi-foldable electronic device.

For example, the multi-foldable electronic device may further include a first hinge cover (e.g., the first hinge cover 410 of FIG. 4A) covering a portion of the first hinge assembly, and a second hinge cover (e.g., the second hinge cover 420 of FIG. 4A), wider than the first hinge cover, covering a portion of the second hinge assembly. The first housing part and the second housing part may be configured to contact each other before the first hinge cover contacts the first housing part and the second housing part. The second housing part and the third housing part may be configured to contact the stopper before the second hinge cover contacts the second housing part and the third housing part.

For example, the second hinge cover may include a through hole (e.g., the through hole 520 of FIG. 5A) that accommodates the stopper. The stopper may be configured to protrude from an outer surface (e.g., the outer surface 425 of FIG. 5A) of the second hinge cover through the through hole such as to contact with the second housing part and the third housing part in the unfolded state of the multi-foldable electronic device. The stopper may be disposed in the through hole such as to form a continuous surface together with the outer surface of the second hinge cover in a multi-folded state (e.g., the second state 101b of FIG. 2B) of the multi-foldable electronic device.

For example, the second hinge cover may further include a guide rail (e.g., the guide rail 521 of FIG. 5A) that guides a position of the stopper and protrudes from an inner surface of the through hole. The stopper may include a guide groove (e.g., the guide groove 511 of FIG. 5A) slidably coupled to the guide rail such that the stopper is moved in a first direction (e.g., the direction 501 of FIG. 5A) and a second direction (e.g., the direction 502 of FIG. 5A) opposite to the first direction with respect to the second hinge cover.

For example, the sliding member may include a first portion (e.g., the first portion 531 of FIG. 5D) coupled to the stopper, a second portion (e.g., the second portion 532 of FIG. 6C) that includes the first sink arm and the second sink arm, the second portion configured to move in accordance with the rotation of the third housing part with respect to the second housing part, and a third portion (e.g., the third portion 533 of FIG. 5D), extending from the first portion to the second portion, providing driving force to the first portion, via the second portion, to move the stopper.

For example, the stopper may include a guide hole (e.g., the guide hole 512 of FIG. 5D). The first portion may include a coupling hole (e.g., the coupling hole 531a of FIG. 5D). The multi-foldable electronic device may further include a coupling pin (e.g., the coupling pin 540 of FIG. 5A) penetrating the guide hole and the coupling hole such that the first portion is slidably coupled to the stopper.

For example, the second hinge assembly may include a hinge bracket including a guide recess, accommodating the third portion of the sliding member, guiding moving of the third portion in a third direction (e.g., the direction 503 of FIG. 5A) and a fourth direction (e.g., the direction 504 of FIG. 5A) opposite to the third direction, the third direction and the fourth direction being longitudinal directions of the third portion.

For example, the second hinge assembly may further include a fastening cover (e.g., the fastening cover 820 of FIG. 8G) coupled on the hinge bracket to prevent the third portion from being separated from the guide recess.

For example, the third portion may include a first shaft portion (e.g., the first shaft portion 533a of FIG. 8E), and a second shaft portion (e.g., the second shaft portion 533b of FIG. 8E) spaced apart from the first shaft portion. The guide recess may include a first recess (e.g., the first recess 635a of FIG. 8F) accommodating the first shaft portion, and a second recess (e.g., the second recess 635b of FIG. 8F) accommodating the second shaft portion. The hinge bracket may further include a protrusion (e.g., the protrusion 810 of FIG. 8E), separating the first recess and the second recess, disposed between the first shaft portion and the second shaft portion.

For example, the second hinge assembly may include a first hinge plate (e.g., the first hinge plate 611 of FIG. 6C) coupled to the second housing part, and a second hinge plate (e.g., the second hinge plate 612 of FIG. 6C) coupled to the third housing part. The second housing part may include a first plate (e.g., the first plate 621 of FIG. 6C), coupled to the first hinge plate to rotate together with the first hinge plate, including a first spiral portion (e.g., the first spiral portion 621a of FIG. 6C). The third housing part may include a second plate (e.g., the second plate 622 of FIG. 6C), coupled to the second hinge plate to rotate together with the second hinge plate, including a second spiral portion (e.g., the second spiral portion 622a of FIG. 6C). The first sink arm may be slidably coupled to the first spiral portion and have a spiral shape corresponding to the first spiral portion to provide axial movement of the third portion through rotation of the first plate. The second sink arm may be slidably coupled to the second spiral portion and have a spiral shape corresponding to the second spiral portion to provide axial movement of the third portion through rotation of the second plate.

For example, the multi-foldable electronic device may further include a first hinge cover covering a portion of the first hinge assembly, wherein the first housing part and the second housing part are configured to cover the first hinge cover while the first housing part and the second housing part are contacting each other in the unfolded state of the multi-foldable electronic device, and a second hinge cover, wider than the first hinge cover, covering a portion of the second hinge assembly and including a vertical surface (e.g., the vertical surface 425a of FIG. 5A), a horizontal surface (e.g., the horizontal surface 425b of FIG. 5A) perpendicular to the vertical surface, and a curved surface (e.g., the curved surface 425c of FIG. 5A) extending from the vertical surface to the horizontal surface. The second hinge cover may include a through hole configured to expose a portion of the stopper to an outside of the multi-foldable electronic device, the through hole formed in a portion of the vertical surface, a portion of the horizontal surface, and a portion of the curved surface.

For example, the stopper may be in contact with a lateral surface (e.g., the lateral surface 220a of FIG. 5A) of the second housing part and a lateral surface (e.g., the lateral surface 230a of FIG. 5A) of the third housing part facing the lateral surface of the second housing part in the unfolded state of the multi-foldable electronic device.

For example, the second hinge assembly may include a first hinge plate coupled to the second housing part, and a second hinge plate coupled to the third housing part. The second housing part may include a first plate, coupled to the first hinge plate to rotate together with the first hinge plate, including first engagement protrusions (e.g., the first engagement protrusions 641 of FIG. 6C). The third housing part may include a second plate, coupled to the second hinge plate to rotate together with the second hinge plate, including second engagement protrusions (e.g., the second engagement protrusions 642 of FIG. 6C). The multi-foldable electronic device may further include a guiding member (e.g., the guiding member 650 of FIG. 6C). The guiding member may include a first engagement portion (e.g., the first engagement portion 651 of FIG. 6C) including third engagement protrusions (e.g., the third engagement protrusions 643 of FIG. 6C) engaged with the first engagement protrusions of the first plate, a second engagement portion (e.g., the second engagement portion 652 of FIG. 6C) including fourth engagement protrusions (e.g., the fourth engagement protrusions 644 of FIG. 6C) engaged with the second engagement protrusions of the second plate, and a connecting portion (e.g., the connecting portion 653 of FIG. 6C) extending from the first engagement portion to the second engagement portion.

For example, the multi-foldable electronic device may further include a first elastic member (e.g., the first elastic member 661 of FIG. 6C) providing an elastic support to the first engagement portion such as to engage the third engagement protrusions with the first engagement protrusions, and a second elastic member (e.g., the second elastic member 662 of FIG. 6C) providing an elastic support to the second engagement portion such as to engage the fourth engagement protrusions with the second engagement protrusions.

For example, the multi-foldable electronic device may further include a flexible display (e.g., the flexible display 240 of FIG. 2A), coupled to the housing. The flexible display may include a first foldable portion (e.g., the fourth display portion 244 of FIG. 2A) configured to be folded by the first hinge assembly as a part of a multi-folded state of the multi-foldable electronic device, and a second foldable portion (e.g., the fifth display portion 245 of FIG. 2A), wider than the first foldable portion, configured to be folded by the second hinge assembly as a part of the multi-folded state of the multi-foldable electronic device.

As described above, a foldable electronic device may include a housing including a first housing part (e.g., the second housing part 220 of FIG. 2A) and a second housing part (e.g., the third housing part 230 of FIG. 2A), and a hinge assembly (e.g., the second hinge assembly 260 of FIG. 3A) rotatably coupling the first housing part and the second housing part. The first housing part and the second housing part may be spaced apart from each other in an unfolded state of the foldable electronic device. The foldable electronic device may include a hinge cover covering a portion of the hinge assembly, the hinge cover including a through hole; and a stopper, slidably coupled to the through hole, configured to protrude from an outer surface of the hinge cover through the through hole to support the first housing part and the second housing part in the unfolded state of the foldable electronic device.

For example, the stopper may be configured to form a continuous surface together with the outer surface of the hinge cover in a folded state of the foldable electronic device.

For example, the hinge cover may further include a guide rail, guiding a position of the stopper, the guide rail protruding from an inner surface of the through hole. The stopper may include a guide groove slidably coupled to the guide rail such that the stopper is configured to be moved in a first direction and a second direction opposite to the first direction with respect to the hinge cover.

For example, the foldable electronic device may further include a sliding member. The sliding member may include a first portion coupled to the stopper, a second portion configured to be slid by rotation of the second housing part with respect to the first housing part, and a third portion, extending from the first portion to the second portion, providing driving force to the first portion, via the second portion, to move the stopper.

For example, the hinge cover may define a vertical surface, a horizontal surface perpendicular to the vertical surface, and a curved surface extending from the vertical surface to the horizontal surface. The through hole may be formed on a portion of the vertical surface, a portion of the horizontal surface, and a portion of the curved surface. The stopper may be in contact with a lateral surface of the first housing part and a lateral surface of the second housing part configured to face the lateral surface of the first housing part in the unfolded state of the foldable electronic device.

Effects of embodiments of the present disclosure are not limited to those described above, and any other effects, of embodiments of the present disclosure, not mentioned herein, will be clearly understood by those having ordinary knowledge in the art to which the present disclosure belongs.

An electronic device according to various embodiments of the present disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., the internal memory 136 or the external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A multi-foldable electronic device comprising:
a housing comprising a first housing part, a second housing part, and a third housing part;
a first hinge assembly rotatably coupling the first housing part and the second housing part;
a second hinge assembly rotatably coupling the second housing part and the third housing part, the second hinge assembly comprising a sliding member comprising a first sink arm and a second sink arm, the sliding member configured to be slid in accordance with linkage between:
spiral surfaces of the first sink arm and the second sink arm, and
rotation of the third housing part and the second housing part with respect to each other; and
a stopper coupled to the sliding member, the stopper configured move in accordance with the rotation of the third housing part with respect to the second housing part,
wherein the stopper is configured to support the second housing part and the third housing part in an unfolded state of the multi-foldable electronic device by the stopper being between the second housing part and the third housing part.

2. The multi-foldable electronic device of claim 1 further comprising:
a first hinge cover covering a portion of the first hinge assembly; and
a second hinge cover covering a portion of the second hinge assembly, wherein the second hinge cover is wider than the first hinge cover,
wherein the first housing part and the second housing part are configured to contact each other before the first hinge cover contacts the first housing part and the second housing part, and
wherein the second housing part and the third housing part are configured to contact the stopper before the second hinge cover contacts the second housing part and the third housing part.

3. The multi-foldable electronic device of claim 2,
wherein the second hinge cover includes a through hole that accommodates the stopper, and
wherein the stopper is configured to:
protrude from an outer surface of the second hinge cover through the through hole such as to contact with the second housing part and the third housing part in the unfolded state of the multi-foldable electronic device; and
be in the through hole such as to form a continuous surface together with the outer surface of the second hinge cover in a multi-folded state of the multi-foldable electronic device.

4. The multi-foldable electronic device of claim 3,
wherein the second hinge cover further comprises a guide rail that is configured to guide a position of the stopper, wherein the guide rail protrudes from an inner surface of the through hole, and
wherein the stopper comprises a guide groove slidably coupled to the guide rail such that the stopper is configured to be moved in a first direction and a second direction opposite to the first direction with respect to the second hinge cover.

5. The multi-foldable electronic device of claim 1, wherein the sliding member comprises:
a first portion coupled to the stopper;
a second portion that comprises the first sink arm and the second sink arm, wherein the second portion is configured to move in accordance with the rotation of the third housing part with respect to the second housing part; and
a third portion extending from the first portion to the second portion, wherein the third portion is configured to provide a driving force to the first portion, via the second portion, such as to move the stopper.

6. The multi-foldable electronic device of claim 5,
wherein the stopper includes a guide hole,
wherein the first portion includes a coupling hole, and
wherein the multi-foldable electronic device further comprises a coupling pin penetrating the guide hole and the coupling hole such that the first portion is slidably coupled to the stopper.

7. The multi-foldable electronic device of claim 5,
wherein the second hinge assembly comprises a hinge bracket including a guide recess, and
wherein the guide recess accommodates the third portion of the sliding member and is configured to guide movement of the third portion in a third direction and a fourth direction opposite to the third direction, the third direction and the fourth direction being longitudinal directions of the third portion.

8. The multi-foldable electronic device of claim 7,
wherein the second hinge assembly further comprises a fastening cover coupled to the hinge bracket, the fastening cover configured to prevent the third portion from being separated from the guide recess.

9. The multi-foldable electronic device of claim 7, wherein the third portion comprises:
a first shaft portion; and
a second shaft portion spaced apart from the first shaft portion,
wherein the guide recess includes:
a first recess accommodating the first shaft portion; and
a second recess accommodating the second shaft portion, and
wherein the hinge bracket further comprises a protrusion that separates the first recess from the second recess, the protrusion being between the first shaft portion and the second shaft portion.

10. The multi-foldable electronic device of claim 5, wherein the second hinge assembly comprises:
a first hinge plate coupled to the second housing part; and
a second hinge plate coupled to the third housing part,
wherein the second housing part comprises a first plate that is coupled to the first hinge plate, the first plate configured to rotate together with the first hinge plate and comprising a first spiral portion,
wherein the third housing part comprises a second plate that is coupled to the second hinge plate, the second plate configured to rotate together with the second hinge plate and comprising a second spiral portion, and
wherein the first sink arm is slidably coupled to the first spiral portion and comprises a first spiral shape corresponding to the first spiral portion, the first spiral shape configured to provide axial movement of the third portion through rotation of the first plate; and
wherein the second sink arm is slidably coupled to the second spiral portion and comprises a second spiral shape corresponding to the second spiral portion, the second spiral shape configured to provide axial movement of the third portion through rotation of the second plate.

11. The multi-foldable electronic device of claim 1, further comprising:
a first hinge cover covering a portion of the first hinge assembly, wherein the first housing part and the second housing part are configured to cover the first hinge cover while the first housing part and the second housing part are contacting each other in the unfolded state of the multi-foldable electronic device; and
a second hinge cover that is wider than the first hinge cover, wherein the second hinge cover covers a portion of the second hinge assembly, and the second hinge cover comprises a vertical surface, a horizontal surface perpendicular to the vertical surface, and a curved surface extending from the vertical surface to the horizontal surface, and
wherein the second hinge cover includes a through hole that is configured to expose a portion of the stopper to an outside of the multi-foldable electronic device, wherein the through hole is in a portion of the vertical surface, a portion of the horizontal surface, and a portion of the curved surface.

12. The multi-foldable electronic device of claim 11,
wherein the stopper is configured to contact a lateral surface of the second housing part and a lateral surface of the third housing part in the unfolded state of the multi-foldable electronic device, and
wherein the lateral surface of the third housing part is configured to face the lateral surface of the second housing part in the unfolded state.

13. The multi-foldable electronic device of claim 1, wherein the second hinge assembly comprises:
a first hinge plate coupled to the second housing part; and
a second hinge plate coupled to the third housing part,
wherein the second housing part comprises a first plate coupled to the first hinge plate, the first plate configured to rotate together with the first hinge plate, and the first plate comprising a first engagement protrusion,
wherein the third housing part comprises a second plate coupled to the second hinge plate, the second plate configured to rotate together with the second hinge plate, and the second plate comprising a second engagement protrusion, and
wherein the multi-foldable electronic device further comprises a guiding member comprising:
a first engagement portion comprising a third engagement protrusion that is configured to engage with the first engagement protrusion of the first plate;
a second engagement portion comprising a fourth engagement protrusion that is configured to be engaged with the second engagement protrusion of the second plate; and
a connecting portion extending from the first engagement portion to the second engagement portion.

14. The multi-foldable electronic device of claim 13 further comprising:
a first elastic member configured to elastically support the first engagement portion such as to engage the third engagement protrusion with the first engagement protrusion; and
a second elastic member configured to elastically support the second engagement portion such as to engage the fourth engagement protrusion with the second engagement protrusion.

15. The multi-foldable electronic device of claim 1, further comprising:
a flexible display coupled to the housing, the flexible display comprising:
a first foldable portion configured to be folded by the first hinge assembly as a part of a multi-folded state of the multi-foldable electronic device; and
a second foldable portion that is wider than the first foldable portion, the second foldable portion configured to be folded by the second hinge assembly as a part of the multi-folded state of the multi-foldable electronic device.

16. A foldable electronic device comprising:
a housing comprising a first housing part and a second housing part;
a hinge assembly rotatably coupling the first housing part and the second housing part, wherein the first housing part and the second housing part are configured to be spaced apart from each other in an unfolded state of the foldable electronic device;
a hinge cover covering a portion of the hinge assembly, the hinge cover including a through hole; and
a stopper, slidably coupled to the through hole, the stopper configured to protrude from an outer surface of the hinge cover through the through hole such as to support the first housing part and the second housing part in the unfolded state of the foldable electronic device.

17. The foldable electronic device of claim 16,
wherein the stopper is configured to form a continuous surface together with the outer surface of the hinge cover in a folded state of the foldable electronic device.

18. The foldable electronic device of claim 16,
wherein the hinge cover further comprises a guide rail that is configured to guide a position of the stopper, the guide rail protruding from an inner surface of the through hole, and
wherein the stopper includes a guide groove that is slidably coupled to the guide rail such that the stopper is configured to be moved in a first direction and a second direction opposite to the first direction with respect to the hinge cover.

19. The foldable electronic device of claim 16 further comprising:
a sliding member comprising:
a first portion coupled to the stopper;
a second portion configured to be slid by rotation of the second housing part with respect to the first housing part; and
a third portion extending from the first portion to the second portion, the third portion configured to provide a driving force to the first portion, via the second portion, such as to move the stopper.

20. The foldable electronic device of claim 16,
wherein the hinge cover comprises a vertical surface, a horizontal surface perpendicular to the vertical surface, and a curved surface extending from the vertical surface to the horizontal surface,
wherein the through hole is in a portion of the vertical surface, a portion of the horizontal surface, and a portion of the curved surface, and
wherein the stopper is configured to contact a lateral surface of the first housing part and a lateral surface of the second housing part in the unfolded state of the foldable electronic device, and
wherein the lateral surface of the second housing part is configured to face the lateral surface of the first housing part in the unfolded state.
